(19) United States
(12) Patent Application Publication
(10) Pub. No.: US 2025/0018654 A1
(43) Pub. Date: Jan. 16, 2025

(54) ADDITIVE MANUFACTURING SYSTEM

(71) Applicant: GENERATIVE PARAMETRICS LIMITED, Melksham Wiltshire (GB)

(72) Inventors: Alex GROFFMAN, Melksham Wiltshire (GB); Tom OLDAKER, Melksham Wiltshire (GB); Mohammad MAHDI EMAMI, Melksham Wiltshire (GB)

(21) Appl. No.: 18/712,150

(22) PCT Filed: Nov. 22, 2022
(86) PCT No.: PCT/GB2022/052951

§ 371 Date: May 21, 2024

(30) Foreign Application Priority Data
Nov. 22, 2021 (GB) 2116811.7
Nov. 22, 2021 (GB) 2116812.5
Nov. 22, 2021 (GB) 2116814.1

(51) Int. Cl. B29C 64/386; B29C 64/209; B33Y 10/00; B33Y 30/00; B33Y 50/00; G05B 19/4099

(52) U.S. Cl. CPC B29C 64/386; B29C 64/209; B33Y 10/00; B33Y 30/00; B33Y 50/00; G05B 19/4099; G05B 2219/49023

(57) ABSTRACT

There is disclosed a method of determining regions for an additive manufacturing system comprising a plurality of printer agents, wherein each of the printer agents is associated with a workspace, and wherein the printer agents are arranged so that at least one pair of adjacent printer agents has intersecting workspaces, the method comprising: identifying a layer of a part; determining a plurality of separate regions associated with the layer, wherein each region is assigned to one of the printer agents; and outputting the plurality of regions.

### FIELD OF THE DISCLOSURE

The present disclosure relates to additive manufacturing systems as well as to methods of operating an additive manufacturing system, and method of determining regions for an additive manufacturing system.

### BACKGROUND TO THE DISCLOSURE

In recent years additive manufacturing has been used in numerous sectors both for prototyping of designs and for larger scale production. An advantage of additive manufacturing is that it enables relatively low cost, and relatively quick, production of prototypes and small runs of parts (as compared to many other processes, such as injection moulding).

However, there is an issue faced by those undertaking additive manufacturing in the trade-off between part volume and fabrication time. In this regard, building large volume (e.g. meter-sized) parts can take days using conventional additive manufacturing systems.

A solution to this problem is desired.

### SUMMARY OF THE DISCLOSURE

According to at least one aspect of the present disclosure, there is described an additive manufacturing system comprising a plurality of printer agents, wherein each of the printer agents is associated with a workspace, and wherein the printer agents are arranged so that at least one pair of adjacent printer agents has intersecting workspaces.

Preferably, the printer agents are arranged so that each pair of adjacent printer agents has intersecting workspaces.

Preferably, the size of the intersection is dependent on a feature of the printer agents.

Preferably, the or each pair of adjacent printer agents is arranged so that the size of the intersection of the workspaces of said pair of printer agents is greater than a minimum possible separation and/or a minimum allowable separation between said pair of adjacent printer agents.

Preferably, the minimum possible separation is dependent on a property of the printer agents. Preferably, the minimum possible separation is dependent on a dimension of the printer agents.

Preferably, the minimum possible separation is dependent on a user input.

Preferably, the workspaces of the printer agents are dependent on the hardware of the printer agents.

Preferably, the workspaces of the printer agents are dependent on software. Preferably, the workspaces of the printer agents are dependent on a user input. Preferably, the size of the intersection is dependent on the hardware of the printer agents. Preferably, the size of the intersection is dependent on software. Preferably, the size of the intersection is dependent on one or more of: a user input; a material being printed; a geometry of a part being printed; and a property (e.g. a dimension) of the printer agents.

Preferably, the printer agents are arranged in a plurality of rows. Preferably, the printer agents are arranged in two rows.

Optionally, the printer agents are arranged in a regular arrangement. Optionally, the printer agents are arranged in an irregular arrangement.

Preferably, the printer agents are arranged in a single row. Preferably, the printer agents are arranged in a curved row.

Preferably, the printer agents are rearrangeable and/or reconfigurable. Preferably, the printer agents are rearrangeable between a set of possible configurations.

Preferably, the additive manufacturing system comprises a plurality of different types of printer agents.

Preferably, the additive manufacturing system comprises at least two printer agents, at least five printer agents, and/or at least ten printer agents.

Preferably, the additive manufacturing system comprises a master controller and one or more slave controllers. Preferably, the additive manufacturing system comprises a slave controller for each row of printer agents and/or for each printer agent.

Preferably, the additive manufacturing system comprises a coordinator. Preferably, each printer agent is arranged to transmit a signal to the coordinator following the completion of a printing step associated with said printer agent.

Preferably, the printer agents comprise one or more of: print heads; printer nozzles; selective compliance assembly robot arms (SCARAs); and printer lasers.

Preferably, the additive manufacturing system comprises a processor for predicting collisions between the printer agents.

According to at least one aspect of the present disclosure, there is described a method of operating an additive manufacturing system according to any preceding claim, the method comprising: identifying a layer of a part; determining a plurality of regions associated with the layer, wherein each region is assigned to one of the printer agents; and operating the printer agents so as to print the regions.

According to at least one aspect of the present disclosure, there is described a method of determining regions for an additive manufacturing system as aforesaid, the method comprising: identifying a layer of a part; determining a plurality of regions associated with the layer, wherein each region is assigned to one of the printer agents; and outputting the plurality of regions.

According to at least one aspect of the present disclosure, there is described a method of determining regions for an additive manufacturing system comprising a plurality of printer agents, wherein each of the printer agents is associated with a workspace, and wherein the printer agents are arranged so that at least one pair of adjacent printer agents has intersecting workspaces, the method comprising: identifying a layer of a part; determining a plurality of separate regions associated with the layer, wherein each region is assigned to one of the printer agents; and outputting the plurality of regions.

Preferably, outputting the regions comprises transmitting the regions to the additive manufacturing system.

Preferably, outputting the regions comprises printing the regions.

Preferably, outputting the regions comprises determining toolpaths for each of the printer agents in dependence on the regions and outputting the toolpaths. Preferably, outputting the regions comprises transmitting the toolpaths to the additive manufacturing system.

Preferably, the method comprises determining the regions in dependence on the workspaces associated with the printer agents and/or in dependence on the intersections associated with the or each adjacent pair of printer agents.

Preferably, the method comprises determining the regions such that a dimension (e.g. the length and/or the width) of each region is equal to and/or greater than a minimum possible separation and/or a minimum allowable separation between the printer agents adjacent said region.

Preferably, the method comprises determining the regions such that a dimension (e.g. the length and/or the width) of each region is equal to and/or greater than a minimum possible separation and/or a minimum allowable separation between each printer agent with a workspace that includes at least a part of said region.

Preferably, the method comprises determining the regions such that a dimension (e.g. the length and/or the width) of each region is equal to and/or greater than a minimum possible separation and/or a minimum allowable separation between each printer agent with a workspace that includes said region.

Preferably, the minimum possible separation is dependent on a dimension (e.g. a size) of the printer agents.

According to at least one aspect of the present disclosure, there is described a method of determining regions for an additive manufacturing system comprising a plurality of printer agents, wherein each of the printer agents is associated with a workspace, and wherein the printer agents are arranged so that at least one pair of adjacent printer agents has intersecting workspaces, the method comprising: identifying a layer of a part; determining a plurality of separate regions associated with the layer, wherein each region is assigned to one of the printer agents, and wherein a dimension of each region is equal to and/or greater than a minimum possible separation between printer agents associated with said region; and outputting the plurality of regions.

Preferably, the printer agents associated with said region comprise a printer agent assigned to print the region and a further printer agent adjacent to said printer agent.

Preferably, the printer agents associated with said region comprise the printer agents with workspaces that includes at least a part of said region.

Preferably, the printer agents associated with said region comprise the printer agents with workspaces that include said region.

Preferably, the method comprises assigning each of the regions to a single printer agent.

Preferably, the method comprises assigning a plurality of regions to one or more of the printer agents. Preferably, the method comprises assigning a plurality of regions to each of the printer agents.

Preferably, each of the regions is associated with a printing step, wherein the associated printer agent is arranged to print the material in said region during said printing step.

Preferably, for each printing step, each printer agent is assigned to a region. Preferably, for each printing step, each printer agent is assigned to a single region.

Preferably, the method comprises determining an order of the printing steps, preferably determining an order for each of the printer agents to print the region(s) assigned to said printer agent.

Preferably, the method comprises determining the order such that each printer agent prints their assigned regions in a clockwise and/or anti-clockwise sequence. Preferably, the method comprises determining the order such that each printer agent prints their assigned regions in a similar sequence and/or the same sequence.

Preferably, the method comprises determining the order such that two or more printer agents print their assigned regions in a different sequence.

Preferably, the method comprises outputting the order.

Preferably, the regions and the printing steps are determined so that, for each printing step, each of the regions printed during said printing step is separated by at least one other region.

According to at least one aspect of the present disclosure, there is described a method of determining regions for an additive manufacturing system comprising a plurality of printer agents, wherein each of the printer agents is associated with a workspace, and wherein the printer agents are arranged so that at least one pair of adjacent printer agents has intersecting workspaces, the method comprising: identifying a layer of a part; determining a plurality of separate regions associated with the layer so that: each region is assigned to one of the printer agents; and each region is associated with a printing step, with the printer agent assigned to the region being arranged to print the material in said region during said printing step; wherein the regions and the printing steps are determined so that, for each printing step, each of the regions printed during said printing step is separated by at least one other region; and outputting the plurality of regions and the printing steps.

Preferably, the method comprises determining the order such that, for each printing step, each of the regions printed during said printing step is separated by only one other region.

Preferably, the method comprises determining the regions in dependence on an area of material within each of said regions. Preferably, the method comprises determining the regions in dependence on the area of material in each of the regions being similar and/or the same.

Preferably, the method comprises determining the regions in dependence on the area of material in the regions associated with each printing step being similar and/or the same.

Preferably, the method comprises determining the regions in dependence on a contribution of the printer agents. Preferably, the method comprises determining the regions in dependence on the contribution of each of the printer agents being similar and/or the same.

Preferably, the method comprises determining the regions in dependence on a contribution of the printed agents during each printing step being similar and/or the same.

Preferably, the method comprises determining the regions so as to minimise the maximum contribution of a printer agent.

Preferably, the method comprises determining the regions so as to minimise the maximum contribution of a printer agent for each of the printing steps.

Preferably, the method comprises determining the regions so as to minimise the total printing time and/or to minimise the printing time for one of the printing steps.

Preferably, the method comprises determining the regions so as to minimise the maximum printing time of an agent.

Preferably, the method comprises determining the regions so as to minimise the maximum printing time of an agent for each of the printing steps.

Preferably, the method comprises determining the regions so as to minimise a movement of the printer agents. Preferably, the method comprises determining the regions so as to minimise a material usage of the printer agents.

Preferably, determining the regions comprises determining the regions using an iterative process.

Preferably, determining the regions comprises determining the regions using machine learning and/or artificial intelligence.

Preferably, determining the regions comprises determining the regions such that each region is located entirely within one of the workspaces.

Preferably, the method comprises dividing the layer into a plurality of polygonal and/or quadrilateral regions, preferably a plurality of rectangular regions.

Preferably, the method comprises assigning the same number of regions to each of the printer agents.

Preferably, the method comprises assigning a number of regions to each printer agent that is equal to and/or greater than to the number of printer agents multiplied by two to the power of the number of dimensions of the arrangement of the agents.

Preferably, the method comprises assigning a number of regions to each printer agent that is equal to and/or greater than the number of printer agents multiplied by two.

Preferably, the method comprises assigning a number of regions to each printer agent that is equal to and/or greater than the number of printer agents multiplied by four.

Preferably, the method comprises assigning a number of regions to each printer agent that is dependent on a configuration of the printer agents.

Preferably, the method comprises assigning a number of regions to each printer agent that is dependent on a dimensionality of a configuration of the printer agents (e.g. whether the printer agents are arranged in a one-dimensional arrangement or a two-dimensional arrangement).

Preferably, the method comprises determining two or more macro-regions, preferably two macro-regions, for each of the printer agents. Preferably, one or more (preferably each) opposing pair of printer agents is associated with the same macro-regions. Preferably, the method comprises determining two or more regions, preferably two regions, for each of the macro-regions.

Preferably, each of the regions are distinct regions.

Preferably, the method comprises determining a configuration of printer agents and/or an optimal configuration of printer agents.

Preferably, the method comprises determining a configuration of printer agents from a set of possible configurations.

Preferably, the method comprises determining a printing time associated with one or more possible configurations. Preferably, the determination of the configuration is dependent on the determined printing time and/or the minimum printing time.

Preferably, the method comprises determining the configuration of printer agents based on one or more of: a user input; a geometry of a part and/or a layer; a property, e.g. a dimension, of the printer agents; and the material being printed.

Preferably, the method comprises determining a configuration of printer agents for a part and/or for a layer.

Preferably, dividing the layer into regions comprises moving the boundaries between a pair of regions in dependence on one or more of: an area of material in each of the pair of regions; a contribution associated with each of the pair of regions; a printing time associated with each of the pair of regions; an overlap between the material in two regions, preferably an overlap between the material in two regions in adjacent layers; and the workspaces of the printer agents associated with each of the pair of regions.

Preferably, the method comprises operating the printer agents to complete a plurality of printing steps. Preferably, each printing step is associated with the printing of a region.

Preferably, the method comprises determining one or more parameters relating to the operation of the printer agents. Preferably, the method comprises determining a first set of parameters after a first printing step and determining a second, different, set of parameters after a second printing step.

Preferably, the method comprises determining a change in the parameters. Preferably, the method comprises determining the change in between a first print step and a second printing step; and/or determining the change during a printing step.

Preferably, the method comprises the parameters comprise one or more of: a printing speed; a printing material; a material feed rate; a material deposition rate; a temperature, preferably a temperature of a material being deposited by one or more of the printer agents; a speed of fans; a region size; and an overlap parameter.

Preferably, the method comprises detecting an error during and/or after a printing step. Preferably, the method comprises halting a printing operation in dependence on the detection of the error. Preferably, the method comprises halting a printing operation of a single printer agent.

Preferably, each printer agent is arranged to return to a standby position after each printing step and/or on detection of an error relating to said printer agent.

Preferably, each printer agent is arranged to return to a standby position after each printing step and/or on detection of an error relating to said printer agent.

Preferably, the method comprises receiving a pause command in relation to one of the printer agents and moving said printer agent to a standby position in dependence on the pause command, preferably receiving the pause command during a printing step.

Preferably, the method comprises determining whether a first of the printer agents has completed a first printing step. Preferably, the method comprises initiating a second printing step for another of the printing agents in dependence on said first printer agent having completed the first printing step.

Preferably, the method comprises determining whether each of (e.g. all of) the printer agents has completed a first printing step. Preferably, the method comprises initiating a second printing step for each of the printing agents in dependence on the printer agents having completed the first printing step.

Preferably, the method comprises determining a toolpath for each of the regions, wherein the printer agents are arranged to print the material in the regions assigned to said printer agents based on the toolpaths.

Preferably, the method comprises determining a toolpath for each of the regions and/or each of the layers for each of the printer agents.

Preferably, the method comprises determining a first toolpath for a first region assigned to the printer agent, determining a second toolpath for a second region assigned to the printer agent, and appending the second toolpath to the first toolpath.

Preferably, the method comprises determining a toolpath for each of the printer agents. Preferably, the method comprises transmitting the toolpath for each of the printer agents to a driver. Preferably, each of the rows of printer agents, and/or each of the printer agents, is associated with a separate driver.

Preferably, the method comprises determining regions and/or toolpaths for multiple layers of the part. Preferably, the method comprises determining regions and/or toolpaths for a plurality of upcoming layers and storing said regions and/or toolpaths in a buffer.

Preferably, the method comprises determining the regions in dependence on an overlap between regions printed by adjacent printer agents.

Preferably, the overlap comprises an overlap between regions printed by adjacent printer agents for different layers of the part, preferably adjacent layers of the part.

Preferably, the overlap comprises an overlap between regions printed by adjacent printer agents for the same layer of the part.

Preferably, the overlap comprises one or more of: an overlap between separate layers of the part; an overlap between adjacent layers of the part; and a regular overlap.

Preferably, the method comprises: identifying a first region of a first layer of the part, the first region being associated with a first printer agent; and determining a second region for a second layer of the part in dependence on the second region of the second layer overlapping the first region of the first layer, the second region being associated with a second printer agent.

According to at least one aspect of the present disclosure, there is described a method of determining regions for an additive manufacturing system as aforesaid, the method comprising: identifying a first layer of a part and a second layer of the part; determining a first plurality of regions associated with the first layer, wherein each region associated with the first layer is assigned to one of the printer agents; determining a second plurality of regions associated with the second layer, wherein each region associated with the second layer is assigned to one of the printer agents; and outputting the second plurality of regions; wherein determining the second plurality of regions comprises determining the second plurality of regions so that a second region of the second plurality of regions that is associated with a second printer agent overlaps with a first region of the first plurality of regions that is associated with a first printer agent.

According to at least one aspect of the present disclosure, there is described a method of operating an additive manufacturing system as aforesaid, the method comprising: identifying a first layer of a part and a second layer of the part; determining a first plurality of regions associated with the first layer, wherein each region associated with the first layer is assigned to one of the printer agents; determining a second plurality of regions associated with the second layer, wherein each region associated with the second layer is assigned to one of the printer agents; and operating the additive manufacturing system so as to print the second plurality of regions; wherein the second plurality of regions is arranged so that a second region of the second plurality of regions that is associated with a second printer agent overlaps with a first region of the first plurality of regions that is associated with a first printer agent.

According to at least one aspect of the present disclosure, there is described a method of operating an additive manufacturing system as aforesaid, the method comprising: identifying a first layer of a part and a second layer of the part; determining a first plurality of toolpaths associated with the first layer, wherein each toolpath of the first plurality of toolpaths is assigned to one of the printer agents; determining a second plurality of toolpaths associated with the second layer, wherein each toolpath of the second plurality of toolpaths is assigned to one of the printer agents; and operating the additive manufacturing system so as to print the second plurality of toolpaths; wherein the second plurality of toolpaths is arranged so that a second toolpath of the second plurality of toolpaths that is associated with a second printer agent overlaps with a first toolpath of the first plurality of toolpaths that is associated with a first printer agent.

According to at least one aspect of the present disclosure, there is described a method of determining regions for an additive manufacturing system comprising a plurality of printer agents, wherein each of the printer agents is associated with a workspace, and wherein the printer agents are arranged so that at least one pair of adjacent printer agents has intersecting workspaces, the method comprising: identifying a first layer of a part and a second layer of the part; determining a first plurality of regions associated with the first layer, wherein each region is assigned to one of the printer agents; and determining a second plurality of regions associated with the second layer, wherein each region Is assigned to one of the printer agents; and operating the printer agents so as to print the regions; wherein determining the second plurality of regions comprises determining the second plurality of regions so that a second region of the second plurality of regions that is associated with a second printer agent overlaps with a first region of the first plurality of regions that is associated with a first printer agent.

Preferably, the method comprises determining a first plurality of toolpaths associated with the first layer and/or a second plurality of toolpaths associated with the second layer, wherein the first plurality of toolpaths is dependent on the first plurality of regions and the second plurality of toolpaths is dependent on the second plurality of regions.

Preferably, the first layer and the second layer are separated by no more than 10 other layers, no more than 5 other layers, and/or no more than 3 other layers.

Preferably, the first layer and the second layer are adjacent layers.

Preferably, the method comprises determining the regions in dependence on an overlap parameter. Preferably, the overlap parameter is dependent on one or more of: a user input; a type of material being used by the printer agents; and a geometry of the part and/or of a layer of the part.

Preferably, the method comprises determining regions for a plurality of layers of the part such that, for each layer, a first region associated with a first printer agent overlaps with a second region associated by a second printer agent. Preferably, the first region and the second region are regions of adjacent layers.

Preferably, the method comprises determining toolpaths for a plurality of layers of the part such that, for each layer, a first toolpath associated with a first printer agent overlaps with a second toolpath associated by a second printer agent. Preferably, the first toolpath and the second toolpath are toolpaths of adjacent layers.

Preferably, the method comprises determining regions for a plurality of layers of the part such that, for each pair of adjacent printer agents, a first region associated with a first printer agent overlaps with a second region associated by a second printer agent. Preferably, the first region and the second region are regions of adjacent layers.

Preferably, the method comprises determining the regions in dependence on a contribution of the printer agents and thereafter modifying the regions in dependence on an overlap.

According to at least one aspect of the present disclosure, there is described a method of calibrating a printer agent of an additive manufacturing system, the method comprising: providing a beam transmitter and a beam receiver, wherein the beam receiver is arranged to receive a beam from the beam transmitter; moving the printer agent towards the beam; detecting a position of the printer agent at which the printer agent disrupts the beam; and calibrating the printer agent in dependence on the detected position.

Preferably, the method comprises: in a first calibration stage: moving the printer agent towards the beam at a first speed; detecting a first stage position of the printer agent at which the printer agent disrupts the beam; and determining an approximate position of the beam relative to the printer agent based on the detected first stage position; and in a second calibration stage: moving the printer agent towards the beam, at a second speed that is slower than the first speed, from a starting position that is determined based on the determined approximate position of the beam relative to the printer agent; detecting a second stage position of the printer agent at which the printer agent disrupts the beam; and calibrating the printer agent in dependence on the detected second stage position.

Preferably, the method comprises estimating a width of the beam at the position of the printer agent, and calibrating the printer agent in dependence on the width.

Preferably, the method comprises: moving the printer agent towards the beam from a first direction; detecting a first position of the printer agent at which the printer agent disrupts the beam from the first direction; moving the printer agent towards the beam from a second direction; detecting a second position of the printer agent at which the printer agent disrupts the beam from the second direction; and calibrating the printer agent in dependence on the detected first position and the detected second position.

Preferably, the method comprises determining a width of the beam based on the detected first position and the detected second position.

Preferably, the method comprises calibrating the printer agent in dependence on the mid-point of the detected first position and the detected second position.

Preferably, the method comprises providing a plurality of pairs of a beam transmitter and a beam receiver arranged along different axes, wherein the method comprises: moving the printer agent towards the beam of a first pair of beam transmitter and beam receiver; detecting a first pair position of the printer agent at which the printer agent disrupts said beam of the first pair; and calibrating the printer agent in a first axis in dependence on the detected first pair position; moving the printer agent towards the beam of a second pair of beam transmitter and beam receiver; detecting a second pair position of the printer agent at which the printer agent disrupts said beam of the second pair; and calibrating the printer agent in a second axis in dependence on the detected first pair position.

Preferably, the beam transmitter and beam receiver comprises a laser beam transmitter and a laser beam receiver.

Preferably, the beam transmitter and/or the beam receiver is moveable, preferably wherein the beam transmitter and/or the beam receiver is arranged to move between the workspaces of different printer agents of the plurality of printer agents.

Preferably, the printer agent is arranged to move towards the beam perpendicularly.

Preferably, the printer agent comprises, and/or is associated with, a blocking component arranged to block the beam.

Preferably, detecting a position at which the printer agent disrupts said beam comprises detecting a drop in an amount of the beam that is received by the beam receiver and/or determining that the beam is no longer received by the beam receiver.

Preferably, calibrating the printer agent comprises determining and/or setting a position of the printer agent on a coordinate system associated with the additive manufacturing system.

According to at least one aspect of the present disclosure, there is described a method of compensating for a difference in height within a layer printed by an additive manufacturing system comprising a plurality of printer agents, the method comprising: capturing a topology of a layer previously printed by the printer agents; and printing a layer in dependence on the captured topology.

Preferably, printing a layer in dependence on the captured topology comprises adjusting a distance between one or more printer agents and a bed of the additive manufacturing system in dependence on the captured topology.

Preferably, the method comprises adjusting the distance so as to reduce an intra-height difference in the height of the layer being printed.

Preferably, the method comprises reducing the height of a printer agent and/or reducing an amount of material deposited by a printer agent when the printer agent is adjacent a raised region of the previously printed layer.

Preferably, the method comprises adjusting the distance so as to ensure that a layer thickness at each point of each layer is equal to or less than a nominal layer thickness.

Preferably, the method comprises adjusting the distance so as to maintain a constant separation between each printer agent and the previously printed layer.

Preferably, capturing a topology comprises capturing a topology using one or more height sensors, preferably one or more height sensors associated with, and/or attached to, the one or more printer agents.

Preferably, the method comprises printing a plurality of layers in dependence on the captured topology, preferably printing a plurality of layers so as to gradually reduce an intra-height difference in each of the plurality of layers.

Preferably, the method is a computer-implemented method.

According to at least one aspect of the present invention, there is described a computer programme product for implementing the aforesaid method.

According to at least one aspect of the present invention, there is described an apparatus arranged to carry out the aforesaid method.

According to at least one aspect of the present invention, there is described apparatus for calibrating a printer agent of an additive manufacturing system, the apparatus comprising: a beam transmitter and a beam receiver, wherein the beam receiver is arranged to receive a beam from the beam transmitter; means (e.g. a processor) for moving the printer agent towards the beam; means for (e.g. a processor for) detecting a position of the printer agent at which the printer agent disrupts the beam; and means for (e.g. a processor for) calibrating the printer agent in dependence on the detected position.

According to at least one aspect of the present invention, there is described an apparatus comprising: a processor for: identifying a layer of a part; and determining a plurality of regions associated with the layer, wherein each region is assigned to one of the printer agents; and a user interface and/or a communication interface for outputting the plurality of regions.

According to at least one aspect of the present invention, there is described an apparatus for determining regions for an additive manufacturing system comprising a plurality of printer agents, wherein each of the printer agents is associated with a workspace, and wherein the printer agents are arranged so that at least one pair of adjacent printer agents has intersecting workspaces, the apparatus comprising: a processor for: identifying a layer of a part; and determining a plurality of separate regions associated with the layer, wherein each region is assigned to one of the printer agents; and a user interface and/or a communication interface for outputting the plurality of regions.

According to at least one aspect of the present invention, there is described an apparatus determining regions for an additive manufacturing system comprising a plurality of printer agents, wherein each of the printer agents is associated with a workspace, and wherein the printer agents are arranged so that at least one pair of adjacent printer agents has intersecting workspaces, the apparatus comprising: a processor for: identifying a layer of a part; determining a plurality of separate regions associated with the layer, wherein each region is assigned to one of the printer agents, and wherein a dimension of each region is equal to and/or greater than a minimum possible separation between the printer agents associated with said region; and a user interface and/or a communication interface for outputting the plurality of regions.

According to at least one aspect of the present invention, there is described an apparatus for determining regions for an additive manufacturing system comprising a plurality of printer agents, wherein each of the printer agents is associated with a workspace, and wherein the printer agents are arranged so that at least one pair of adjacent printer agents has intersecting workspaces, the apparatus comprising: a processor for: identifying a layer of a part; determining a plurality of separate regions associated with the layer so that: each region is assigned to one of the printer agents; and each region is associated with a printing step, with the printer agent assigned to the region being arranged to print the material in said region during said printing step; wherein the regions and the printing steps are determined so that, for each printing step, each of the regions printed during said printing step is separated by at least one other region; and a user interface and/or a communication interface for outputting the plurality of regions and the printing steps.

According to at least one aspect of the present invention, there is described an apparatus for determining regions for an additive manufacturing system comprising a plurality of printer agents, wherein each of the printer agents is associated with a workspace, and wherein the printer agents are arranged so that at least one pair of adjacent printer agents has intersecting workspaces, the apparatus comprising: a processor for: identifying a first layer of a part and a second layer of the part; determining a first plurality of regions associated with the first layer, wherein each region is assigned to one of the printer agents; determining a second plurality of regions associated with the second layer, wherein each region is assigned to one of the printer agents; and a user interface and/or a communication interface for outputting the regions; wherein determining the second plurality of regions comprises determining the second plurality of regions so that a second region of the second plurality of regions that is associated with a second printer agent overlaps with a first region of the first plurality of regions that is associated with a first printer agent.

According to at least one aspect of the present invention, there is described an apparatus for compensating for a difference in height within a layer printed by an additive manufacturing system comprising a plurality of printer agents, the apparatus comprising: a sensor for capturing a topology of a layer previously printed by the printer agents; and one or more printing agents for printing a layer in dependence on the captured topology.

Preferably, the apparatus is a computer device.

According to at least one aspect of the present invention, there is described a system comprising an apparatus as aforesaid and an additive manufacturing system as aforesaid.

Preferably, the apparatus is arranged to output the regions and/or a toolpath to the additive manufacturing system.

According to at least one aspect of the present invention, there is described a system comprising: an additive manufacturing system comprising a plurality of printer agents, wherein each of the printer agents is associated with a workspace, and wherein the printer agents are arranged so that at least one pair of adjacent printer agents has intersecting workspaces; and an apparatus comprising: a processor for: identifying a layer of a part; determining a plurality of separate regions associated with the layer, wherein each region is assigned to one of the printer agents; and optionally, determining a toolpath for the printer agents in dependence on the regions; and a communication interface for outputting the plurality of regions and/or the toolpaths to the additive manufacturing system.

Any feature in one aspect of the disclosure may be applied to other aspects of the invention, in any appropriate combination. In particular, method aspects may be applied to apparatus aspects, and vice versa.

Furthermore, features implemented in hardware may be implemented in software, and vice versa. Any reference to software and hardware features herein should be construed accordingly.

Any apparatus feature as described herein may also be provided as a method feature, and vice versa. As used herein, means plus function features may be expressed alternatively in terms of their corresponding structure, such as a suitably programmed processor and associated memory.

It should also be appreciated that particular combinations of the various features described and defined in any aspects of the disclosure can be implemented and/or supplied and/or used independently.

The disclosure extends to methods and/or apparatus substantially as herein described with reference to the accompanying drawings.

The disclosure will now be described, by way of example, with reference to the accompanying drawings.

### DESCRIPTION OF THE DRAWINGS

FIGS. 1a, 1b, and 1c show, respectively, a perspective view, a plan view, and a side view of an additive manufacturing system comprising a plurality of printer agents.

FIGS. 1d-1i show further possible arrangements of printer agents.

FIG. 2 shows a depiction of the workspaces of the printer agents of FIGS. 1a, 1b, and 1c.

FIGS. 3a and 3b illustrate computer devices, and systems comprising computer devices, on which the methods, apparatuses, and systems disclosed herein may be implemented.

FIGS. 4 and 5 illustrate a method of forming a layer of a part using the printer agents.

FIGS. 6a and 6b show a method of dividing a layer into regions.

FIGS. 7a-7d show a method of forming the layer based on the regions.

FIGS. 8 and 9 illustrate a method of determining regions for a layer.

FIGS. 10a and 10b show an alternative arrangement of printer agents.

FIG. 11 shows a method of providing code to printer agents to enable the printing of a part.

FIG. 12 show a method of determining a toolpath for a printer agent.

FIGS. 13a and 13b show methods of coordinating the printer agents so as to print a part. FIG. 13c shows a standby placement of printer agents.

FIGS. 14a-14c illustrate methods of dividing a layer into regions.

FIGS. 15a-15c show arrangements in which regions printed by different printer agents overlap.

FIGS. 16 and 17a-17e illustrate a method of providing an overlap as shown by FIG. 15c.

FIG. 18 shows a method of determining a toolpath in dependence on an overlap parameter.

FIGS. 19 and 20 show examples of overlapping layers.

FIGS. 21a and 21b show examples of parts formed of different types of sections.

FIGS. 22a and 22b show arrangements of printer agents with different movement ranges. FIG. 22c illustrates a method of determining regions for a layer using the arrangement of FIG. 22b.

Referring to FIGS. 23a and 23b, a method of compensating for a difference in the height of a substrate and/or a printed layer.

FIGS. 24a-24e illustrate methods of, and arrangements for, calibrating the printer agents.

### DESCRIPTION OF THE PREFERRED EMBODIMENTS

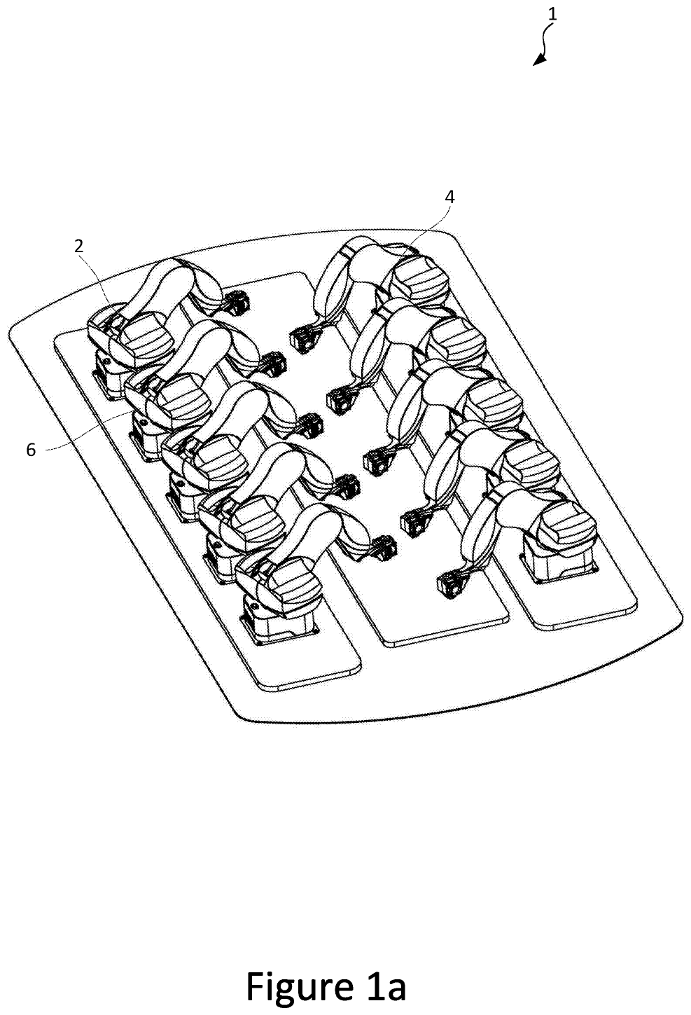

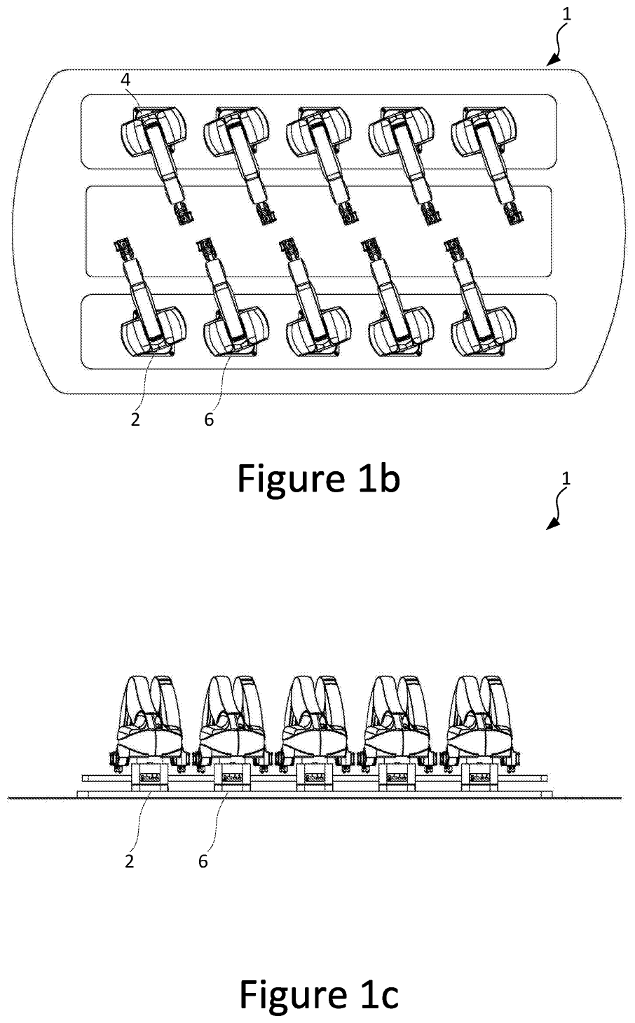

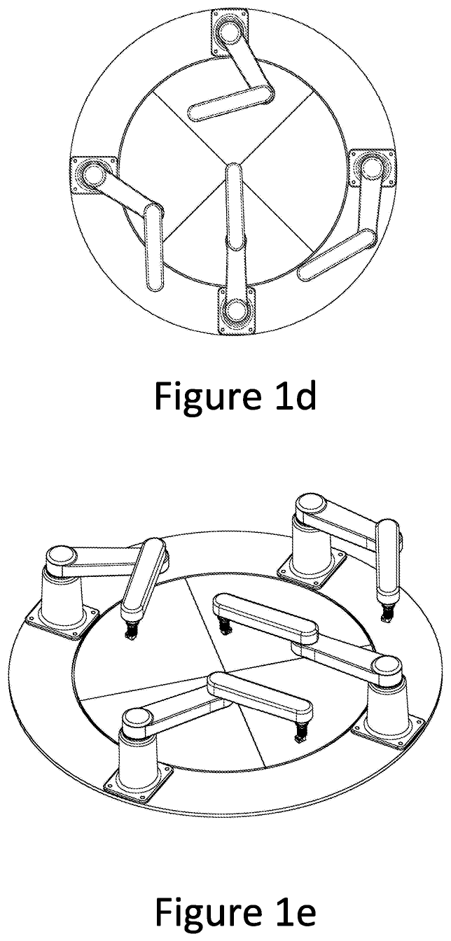

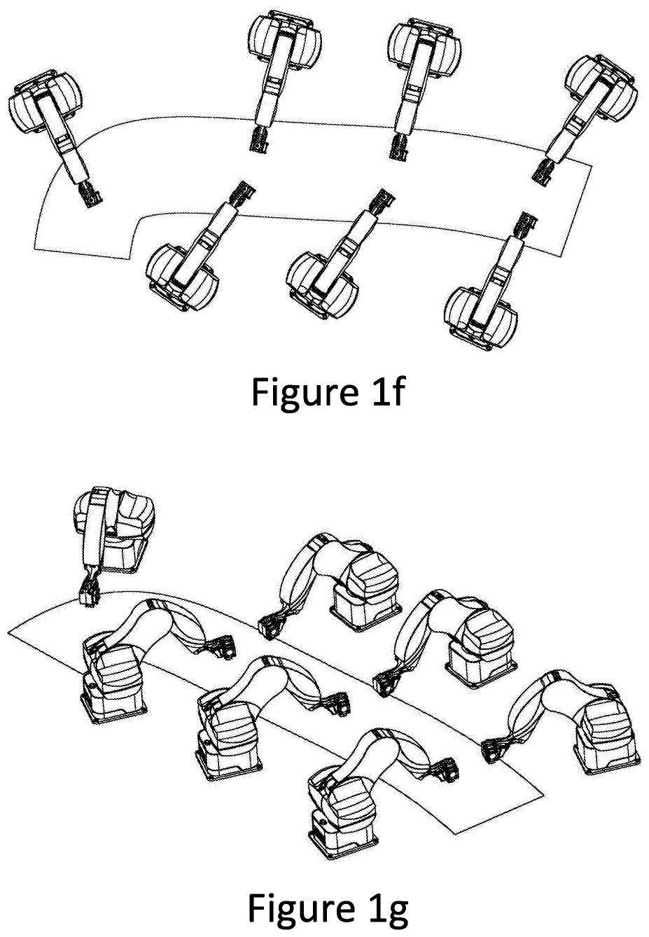

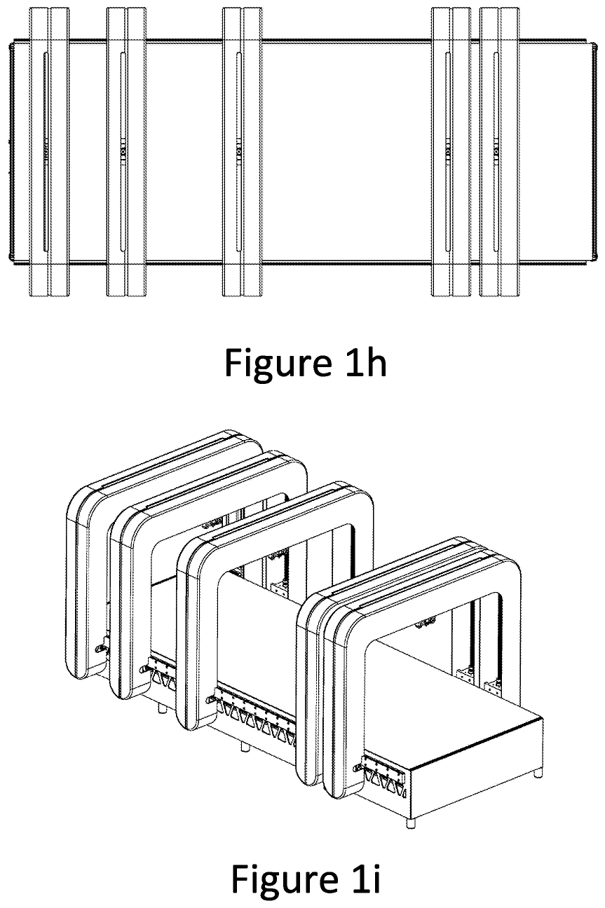

Referring to FIGS. 1a, 1b, and 1c, there is shown an additive manufacturing system 1 that comprises a plurality of printer agents including a first printer agent 2, a second printer agent 4, and a third printer agent 6.

The printer agents of the additive manufacturing system 1 are arranged in two rows, where the first printer agent 2 and the second printer agent 4 are arranged adjacent each other (e.g. in the same column of adjacent rows) and the first printer agent and the third printer agent are arranged adjacent each other (e.g. in adjacent columns of the same row).

It will be appreciated that any arrangement of printer agents may be used (e.g. any number of rows and/or any layout) and that irregular arrangements may be used.

In this regard, FIGS. 1d-1i show alternative arrangements of printer agents that may be used with the systems and methods disclosed herein. Specifically, FIGS. 1d and 1e shows an additive manufacturing system comprising a plurality of selective compliance assembly robot arms (SCARAs) arranged in a circle. FIGS. 1f and 1g show an arrangement where two rows of printer agents are arranged to work on a curved part. FIGS. 1h and 1i show a gantry arrangement (where the gantries are able to move along the additive manufacturing system). With each of these arrangements, there is at least one pair of adjacent agents that have overlapping work areas. Indeed, the SCARA arrangement may be configured so that each arm is able to work on any area in the additive manufacturing system, e.g. so that the work areas of each printer agent overlap. The arrangement of printer agents may for example, depend on the available componentry, the part being printed, or the material being used to print the part.

Returning to the arrangement of FIGS. 1a, 1b, and 1c, in an exemplary embodiment, two rows of five nozzles are used where this can allow work on parts of greater than one meter in length and/or greater than 0.5 m² in cross-sectional area.

In this additive manufacturing system 1, each printer agent is arranged to have a workspace, where the printer agent is able to dispense material inside this workspace. The workspace of a given printer agent is typically determined by the position of that agent around the geometry to be printed, so that each workspace may be modified by moving the corresponding printer agents. Equally, a workspace may be defined in software, where the workspace may then be modified by modifying the software. By using a plurality of printer agents, an additive manufacturing system can be provided that is able to print a part more quickly than a system with a single printer agent.

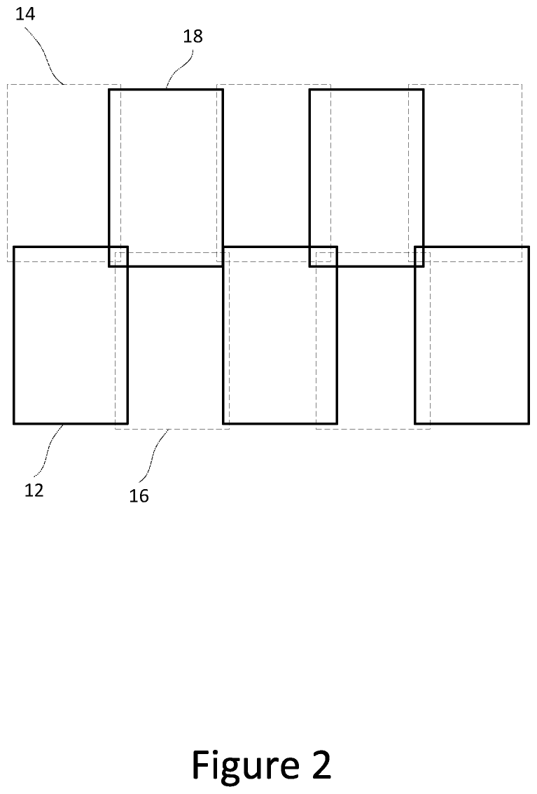

Referring to FIG. 2, according to the present disclosure, at least one pair of adjacent printer agents is arranged so that the workspaces associated with these printer agents have an intersection (this could equally be termed as a ‘cross over’ or an ‘overlap’). In other words, there is an intersection area in which the workspaces of the two printer agents intersect (e.g. overlap), where each printer agent of the pair of printer agents is able to dispense material in this intersection area. Referring to the exemplary arrangement of FIG. 2, a first workspace 12 associated with the first printer agent 2 is arranged to intersect with a second workspace 14 associated with the second printer agent 14. In this embodiment, the first workspace is also arranged to intersect with a third workspace 16 associated with the third printer agent 6. More generally, in this embodiment, the printer agents are arranged so that each pair of adjacent printer agents have intersecting workspaces in both of the row and column directions.

The size of the intersection of each pair of printer agents is typically defined by the hardware of the printer agents, where the printer agents may be located close together so as to provide a substantial intersection of the workspaces. Equally, the intersection of each pair of printer agents may be defined by software, where this software may define a workspace and/or an intersection for any of the printer agents that is less than or equal to a maximum workspace and/or intersection (with this maximum workspace and/or intersection being dependent on physical constraints).

The size of the intersection between workspaces of adjacent printer agents may vary depending on the implementation. For example, where it is desired to print large parts, the printer agents may be spread out and so the size of the intersection may be relatively small. Where it is desired to print smaller parts, the printer agents may be moved closer together so that the size of the intersection increases. The printer agents may be reconfigurable to alter the size of the intersection, where the additive manufacturing system 1 and/or the printer agents may comprise a motor arranged to move a base of the printer agents to alter the intersection. Typically, the intersection between printer agents is arranged to be at least 10 mm, at least 20 mm, and/or at least 30 mm. This intersection may depend on one or more of: the physical dimensions of the additive manufacturing system 1 and/or the printer agents; a user input; the material being used for the printing; and the object being printed.

Where the term ‘adjacent’ is used here in relation to printer agents/workspaces it typically includes the diagonal direction, so that the first workspace 12 typically intersects with a fourth workspace 18, which fourth workspace is associated with a fourth printer agent. The extent of the intersection between the first workspace and the fourth workspace is typically small as compared to the intersection between the first workspace and the second/third workspaces.

The printer agents are typically arranged so that the intersection between the workspaces of a pair printer agents is greater than a minimum allowable (and/or minimum possible) separation between said pair of printer agents. The minimum allowable separation is typically associated with a size of the printer agents (where smaller printer agents are able to work close to each other and large printer agents must maintain a larger separation to avoid collisions).

It will be appreciated that numerous arrangements of printer agents and workspaces are possible. For example, the printer agents may be arranged in two regular rows as shown in the additive manufacturing system 1 of FIG. 1a. Equally, the rows may be irregular so that the workspaces of the nozzles do not align exactly (as shown in FIG. 2). Furthermore, numerous other arrangements of printer agents are possible (and some of these are described in more detail below).

The printer agents may be similar and/or may be the same (e.g. the same type of agent and/or the same size of agent, etc.). Equally, a plurality of different types of printer agents may be provided. For example, the printer agents at the centre of each row are often required to print more material than the printer agents at the ends of the rows and so one or more of the central printer agents may comprise a more capable and/or quicker-printing mechanism than one or more of the outer and/or edge printer agents.

As is described below, the use of printer agents with intersecting workspaces enables the provision of an additive manufacturing system that is able to quickly manufacture parts.

The printer agents are typically print heads and/or printer nozzles that dispense material so as to build up a part—and this detailed description primarily discloses forming a part by dispensing material from the printer agents. It will be appreciated that more generally the disclosures herein relate to any printer mechanisms that can be used for additive manufacturing and/or 3D printing (e.g. including subtractive manufacturing). For example, the printer mechanisms may comprise lasers that are arranged to fuse materials together and/or that are arranged to cut material. Further, the printer agents may comprise robotic arms that are able to stitch together fibres and/or materials.

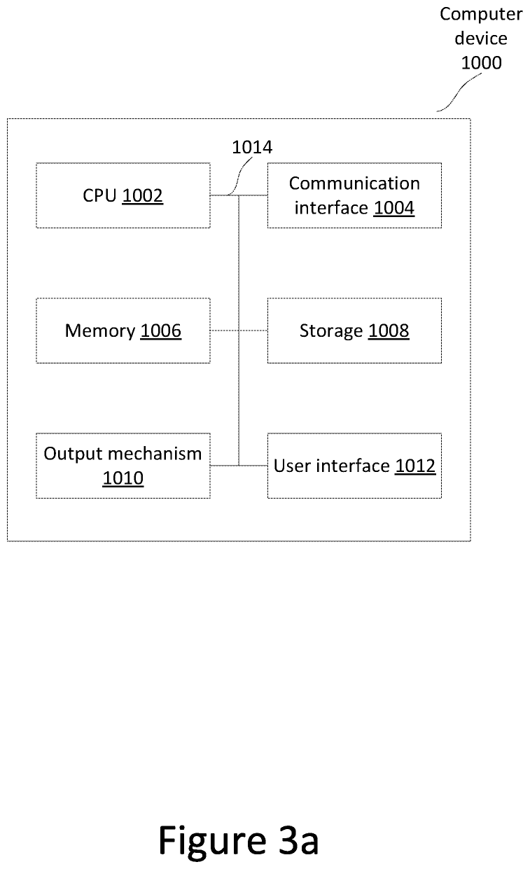

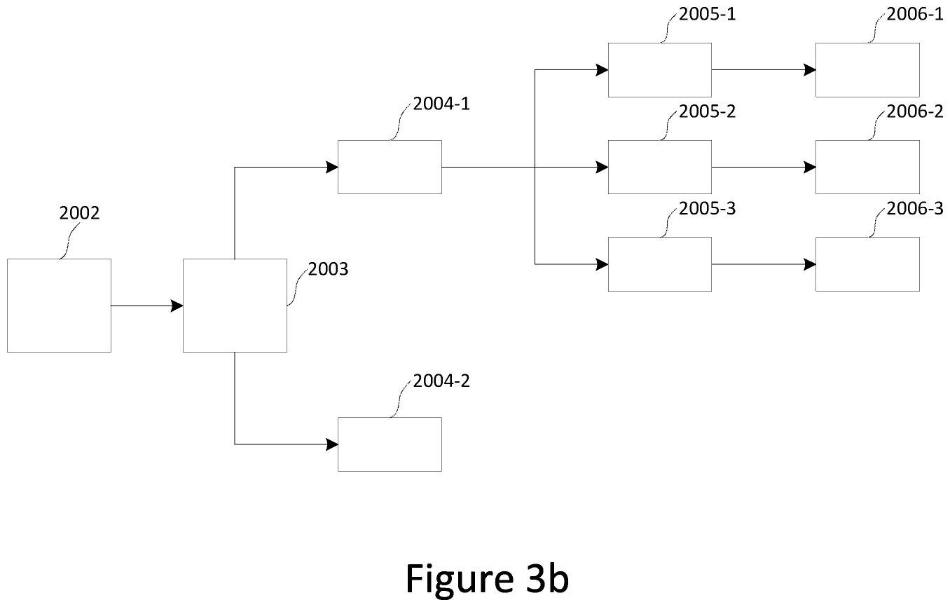

Referring to FIG. 3a, the additive manufacturing system 1 comprises a computer device 1000. Aspects of the methods, apparatuses, and systems disclosed herein may be implemented on this computer device of the additive manufacturing system. Furthermore, aspects of the methods, apparatuses, and systems disclosed herein may be performed on other computer devices.

Each computer device 1000 typically comprises a processor in the form of a CPU 1002, a communication interface 1004, a memory 1006, storage 1008, an output mechanism 1010 and a user interface 1012 coupled to one another by a bus 1014.

The CPU 1002 executes instructions, including instructions stored in the memory 1006, the storage 1008, and/or the removable storage 1010.

The communication interface 1004 is typically an Ethernet network adaptor coupling the bus 1014 to an Ethernet socket. The Ethernet socket is coupled to a network, such as the Internet. The communication interface facilitates communication between the nodes of the blockchains and enables each node to validate and propagate transactions and each miner to propose blocks to the network. It will be appreciated that any other communication medium may be used by the communication interface, such as area networks, infrared communication, and Bluetooth®.

For the additive manufacturing system 1, the communication interface 1004 is typically arranged to enable communication between the printer agents and another computer device. In particular, instructions for each printer agent may be formed at this other computer device and then transmitted to the printer agents of the additive manufacturing system via the communication interface. Each printer agent may have a separate communication interface and/or the additive manufacturing system may have a general communication interface.

The memory 1006 stores instructions and other information for use by the CPU 1002. The memory is the main memory of the computer device 1000. It usually comprises both Random Access Memory (RAM) and Read Only Memory (ROM).

The storage 1008 provides mass storage for the computer device 1000. In different implementations, the storage is an integral storage device in the form of a hard disk device, a flash memory or some other similar solid state memory device, or an array of such devices.

The output mechanism provides a way for the computer device to affect the environment around the computer device; for the additive manufacturing system 1 the output mechanism comprises the printer agents. It will be appreciated that a computing device may be provided without such an output mechanism.

The user interface 1012 enables a user to interact with the computer device 1000 and may comprise a display 2016 and/or an input/output device such as a keyboard and a mouse.

A computer device as described may be used to implement aspects of the additive manufacturing system 1; equally, a separate computer device may be used: to determine information/instructions that can be transmitted to the additive manufacturing system; to configure the additive manufacturing system; and/or to evaluate the performance of the additive manufacturing system.

A computer program product is provided that includes instructions for carrying out aspects of the method(s) described below. The computer program product is stored, at different stages, in any one of the memory 1006, storage device 1008 and a removable storage. The storage of the computer program product is non-transitory, except when instructions included in the computer program product are being executed by the CPU 1002, in which case the instructions are sometimes stored temporarily in the CPU or memory. It should also be noted that there may be provided removable storage that is removable from the computer device 1000, such that the computer program product may be held separately from the computer device from time to time. Different computer program products, or different aspects of a single overall computer program product, may be present on various computer devices that form a system including the additive manufacturing system 1.

The additive manufacturing system 1 may comprise a single computer device. Referring to FIG. 3b, which shows an exemplary implementation of the additive manufacturing system 1, each printer agent, and/or each row of printer agents, of the additive manufacturing system may be associated with a separate computer device.

Referring to FIG. 3b, a master controller 2002 is arranged to provide instructions to a first slave computer device 2004-1 and a second slave computer device 2004-2 via a switch 2003. These slave computer devices may, for example, comprise control boards and/or Raspberry Pi™ devices. Typically, each printer agent, and/or each row of printer agents, is controlled by a separate slave computer device.

Each slave computer device controls a number of drivers 2005-1, 2005-2, 2005-3, which in turn control motion output devices (e.g. stepper motors) 2006-1, 2006-2, 2006-3. The motion output devices control the printer agents to enable the accurate dispensing of material so as to form a part.

This arrangement improves the scalability of the additive manufacturing system and enables the simple addition of further printer agents (e.g. by connecting a further slave computer device and/or further drivers that are associated with these further printer agents). In this regard, each printer agent may be associated with one or more sensors, drivers, motion output devices, etc. These components may all be connected to a slave computer device associated with the printer agent and this slave computer device may then be connected to the master controller 2002. The configuration of the components, and the connection of these components to the slave computer device may occur before the connection of the slave computer device to the master controller so that the connection of the slave computer device to the master controller—and the installation of the printer agent in the additive manufacturing system 1—is straightforward.

This arrangement also enables a range of different types of printer agents and components to be used in the additive manufacturing system 1, where the slave computer devices of each agent may differ. The master controller 2002 can then feed appropriate instructions to each of the different slave computer devices (e.g. one slave computer device may receive assembly code and another may receive C++ code).

Furthermore, this arrangement distributes the computational load between multiple devices to reduce response times and latencies. The arrangement can also be used to provide redundancy in the event that one of the slave computer devices malfunctions; in such a situation the remaining slave computer devices may complete the tasks that were initially assigned to the malfunctioning slave computer device.

Using the master controller 2002 to feed independent data streams to a plurality of slave computer devices enables each slave computer device to retain a portion of data to work through. This means that any drops in data transmission between the master controller and the slave computer devices can be absorbed without effecting the overall printing process.

Typically, the slave computer devices are located near to and/or adjacent the control points of the additive manufacturing system 1 (e.g. the motion output devices and the sensors) and these slave computer devices are then connected to the master controller 2002 so that the additive manufacturing system can be controlled using a single data input at the master controller. The master controller and the slave computer devices may be connected by cables and/or may communicate wirelessly.

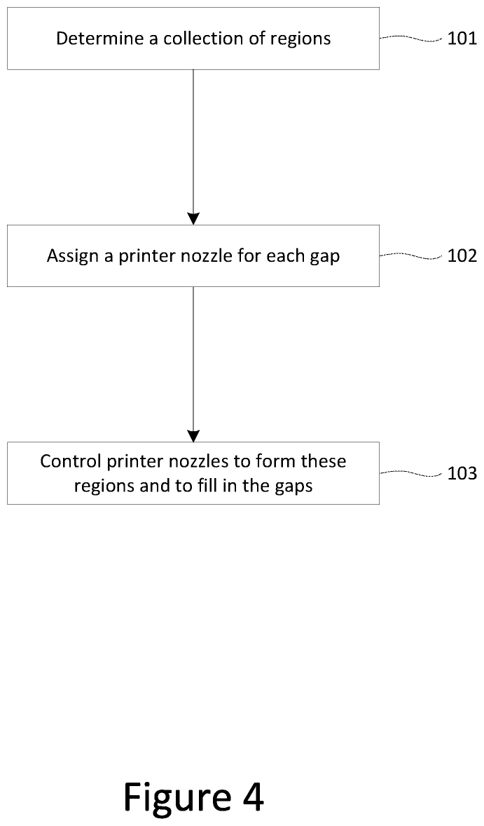

Referring to FIG. 4, a method of operating the additive manufacturing system 1 is described. This method is typically performed by a computer device that is a part of the additive manufacturing system. Equally, aspects of this method may be performed by another computer device and the information may then be transmitted to the additive manufacturing system. In particular, the regions may be determined by a separate device and then transmitted to the additive manufacturing system. Indeed, the separate computer device may determine toolpaths for the printer agents based on the regions and then transmit these toolpaths to the additive manufacturing system (with this arrangement, the additive manufacturing system may not have direct knowledge of the regions, but it will still operate in dependence on the regions).

In a first step 101, the computer device determines a collection of regions for a layer, wherein each region of the collection of regions is associated with one of the printer agents. More specifically, each region is determined so that an associated printer agent is able to print the region (printing the region here refers to the printer agent printing, or more generally forming, an amount of material located within the region).

In this regard, in order to form a part the printer agents are typically arranged to build up the part layer by layer. For each of these layers, the computer device determines a collection of regions, where each of the regions is assigned to a printer agent for printing. Since the printer agents are able to work simultaneously (e.g. in parallel), the plurality of printer agents is able to print a layer more quickly than a single printer agent working alone).

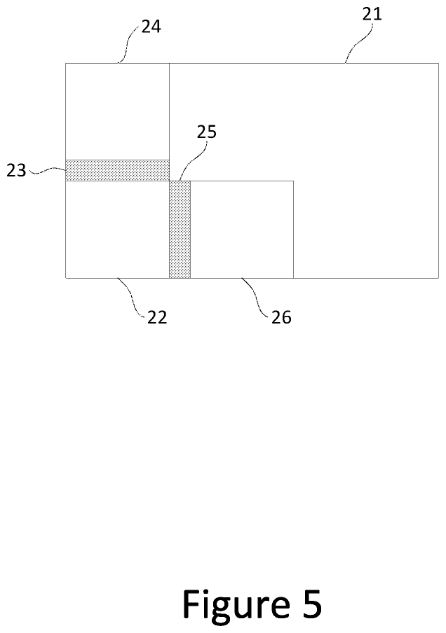

Referring to FIG. 5, there is described a simple example in which the additive manufacturing system is used to print a solid cuboid 21. For a given layer of this cuboid, the first printer agent 2 is assigned a first region 22, the second printer agent is assigned a second region 24, and the third printer agent is assigned a third region 26.

The computer device determines the regions such that there is a gap between each pair of adjacent regions that is being printed by the printer agents. This gap may be considered to itself be a region (e.g. a gap region). The size of the gap is typically dependent on the printer agents associated with any regions adjacent to the gap. Specifically, the gap is sized in order to avoid collisions between the printer agents working in adjacent regions.

Therefore, the size of a first gap 23 that is located between the first region 22 and the second region 24 is dependent on the size of the first printer agent 2 and the size of the second printer agent 4 and the size of a second first gap 25 that is located between the first region 22 and the third region 26 is dependent on the size of the first printer agent 2 and the size of the third printer agent 6. Typically, each gap size is determined based on the minimum possible distance between the two relevant printer agents that prevents a collision; therefore, each printer agent can work freely in its assigned region without fear of a collision.

In a second step 102, the computer device assigns printer agents to fill in each gap.

With the example of FIG. 5, the first printer agent 2 may be assigned to fill in the first gap 23 and the third printer agent 6 may be assigned to fill in the second gap 25.

Typically, the determination of the regions, and the assignments of the printer agents, is arranged so that each printer agent fills in at most one gap.

Similarly, the gaps may be determined so that at most one gap is located in a single workspace. For example, the first gap 23 may be determined so that it is located in the first workspace 12 and the second gap may then be determined so that it is not located in the first area but rather is located solely in the third workspace 16.

In a third step 103, the computer device controls the printer agents so as to form the regions and fill in the gaps.

This process is then repeated for each layer of a part.

The printing process for each layer typically comprises a number of printing steps so that, in a first step: the first printer agent 2 prints the first region 24; the second printer agent 4 prints the second region 26; and the third printer agent 6 prints the third region 26, and in a second step: the first printer agent prints the first gap 23; and the third printer agent prints the second gap 25. While this example only considers a two-step printing process, more generally any number of printing steps may be used. As described below, typically four printing steps are used, since this allows high efficiency printing while maintaining a gap between adjacent printer agents at each step.

The determination of the regions and gaps for each of the layers is typically performed on a separate computer device before instructions relating to these regions and gaps are transmitted to the additive manufacturing system 1. For example, the separate computer device may determine, and then transmit, a series of printing instructions for each of the printer agents, where these printing instructions are associated with the forming of the regions and the filling in of the gap regions. This enables a separate computer device with a large amount of processing power to determine the regions.

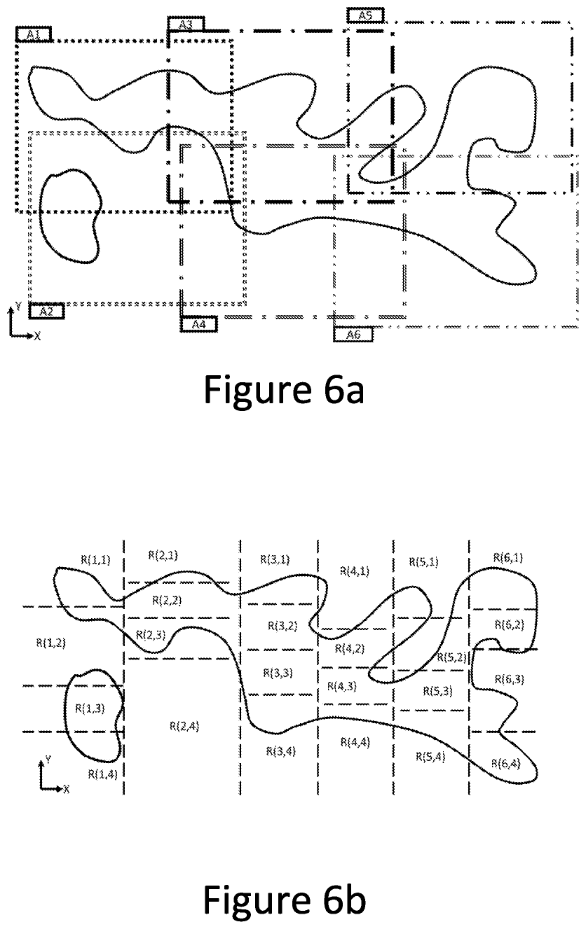

Referring to FIGS. 6a and 6b, there is described in more detail a method of dividing a layer into a plurality of regions.

FIG. 6a shows an exemplary arrangement of six printer agents (A1-A6), where each printer agent is associated with a workspace. As shown by FIG. 6a, each adjacent pair of printer agents is arranged so that said pair of printer agents has intersecting workspaces. FIG. 6a also shows an exemplary layer of material for printing by the printer agents.

An exemplary segmentation (or dividing) process is shown in FIG. 6b. With this segmentation process, a layer is divided into ‘macro-regions’ along the x-axis and each of these x-axis macro-regions is then divided into (smaller) regions along the y-axis. It will be appreciated that the determination of regions could begin with division into y-axis macro-regions followed by division into regions. Equally, the division of the layer into regions could occur in a single step.

It will also be appreciated that any references in this document to ‘macro-regions’—e.g. references to methods of determining macro-regions—apply equally to ‘regions’ and vice versa.

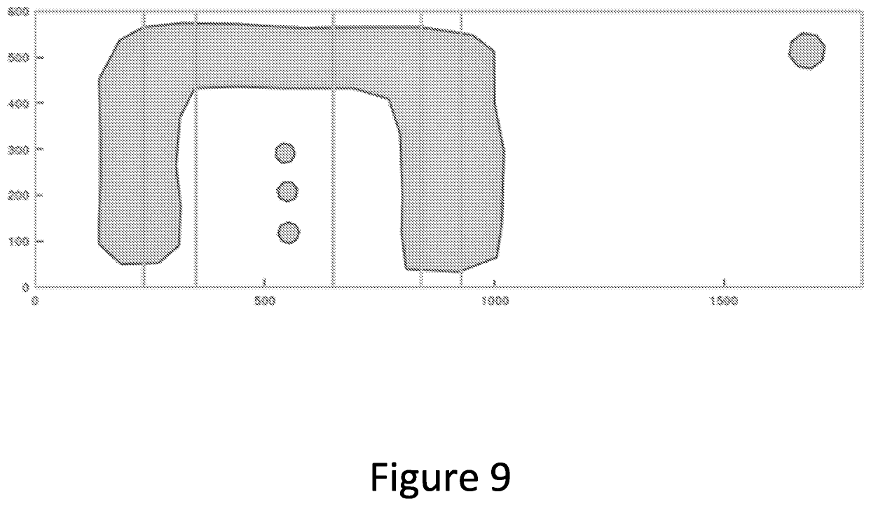

For two dimensional grid layouts of printer agents, the layer is typically divided into at least (or exactly) as many regions as the number of printer agents multiplied by two to the power of the number of dimensions of the arrangement of the agents. So with the 2D example of FIG. 6b that comprises two rows of agents with three agents per row the layer is divided into 2*2*2*3=24 separate regions. And with the 1D example of FIG. 9b—which shows an arrangement of five agents located in a single dimension (along a curved line)—the layer is divided into 2*1*5=10 regions. The use of a number of regions that is the number of printer agents multiplied by two to the power of the number of dimensions ensures that each printer agent is able to work on a region simultaneously while keeping a gap between the printer agents. In this regard, the additive manufacturing system 1 typically uses a one dimensional arrangement (such as that of FIG. 9b) in which the number of regions used is at least twice the number of printer agents or a two dimensional arrangement (such as that of FIG. 6b) in which the number of regions used is at least four times the number of printer agents (and where a two dimensional arrangement is used, this typically comprises two rows of printer agents). Three dimensional arrangements, in which printer agents are located, and work, above and/or beneath each other are possible but unusual since this typically requires the material to be supported during printing (whereas in a two dimensional arrangement each layer is supported by the previous layer). Three dimensional arrangements of printer agents may be used, for example, where the part comprises a frame to which material is added. In such a case, agents are able to work in three dimensions since the frame supports the material.

A three dimensional arrangement may also be provided in which the printer agents are able to rotate in order to position the agents at a different angle to an object. In such an arrangement, the printer agents may still print two-dimensional layers, where the layers may be printed at a plurality of different angles/orientations. More generally, the printer agents and/or the machine may be able to rotate and/or translate so as to work in three dimensions.

The segmentation (and/or division) of the layer into macro-regions and/or into regions may depend on one or more of:
An area, volume, and/or amount of material each region. In particular, the layer may be divided into regions with similar (or equal) areas of material.
A contribution and/or a maximum contribution of a printer agent. Typically the layer is divided in dependence on the contribution of each printer agent being equal (where exactly equal contributions may not be possible due to the geometry of the layer and the workspaces of the various printer agents).
   The ‘contribution’ of a printer agent typically relates to the time required for an agent to print a region. Therefore, dividing a layer so that each printer agent has an equal contribution refers to dividing a layer so that each printer agent requires the same amount of time to print the material within the assigned region(s).
   Typically, the contribution is related to the amount of material being printed; however, there may be some situations in which a printer agent that is assigned to print a small amount of material has a comparatively large contribution (e.g. because the small amount of material is distributed around the printing region).
In some embodiments, the layer may be divided in order to minimise the maximum contribution of any printer agent. The time taken to form a layer typically depends on the printer agent with the maximum contribution (where the other printer agents will finish before this maximum-contribution printer agent). Therefore, the segmentation may be performed so as to minimise the contribution of the maximum-contribution printer agent. The segmentation may be performed so as to minimise the contribution of the maximum-contribution printer agent overall and/or for each step. As described above, printing the layer typically involves a plurality of printing steps, and these printing steps may each have a different time. Therefore, the division into regions may be performed so as to ensure that, at each printing steps, the contribution of each agent is similar (and there may then be short printing step during which each agent has a small contribution and long printing steps during which each agent has a large contribution).
A printing time associated with a region. Similarly to minimising the contribution, the segmentation may be performed to minimise the printing time of the longest-time printer agent either for a whole layer and/or for an individual printing step.
A movement of printing agents. The segmentation may be performed to minimise the movement of the printing agents in order to avoid wear. Typically, such a segmentation also leads to low printing times.
An intersection between workspaces. Since each printer agent is typically arranged so that only adjacent nozzles have intersecting workspaces (e.g. so that A1 intersects with A3 but not A5), it may not be possible to divide a layer into regions of equal area. For example, if there is a lot more material to one side of a layer the printer agents to this side will typically need to perform more work to form the layer. In such a case, the division typically still minimises the contribution of each printer agent bearing in mind the movement constraints of the nozzle. Where the computer device is attempting to divide a layer into regions of the same area of material given the constraints imposed by the workspaces, the division into regions is considered ‘dependent on’ the area of material in each region being the same even though, in practice, it may not be possible to divide the layer such that the area of material in each region is the same (and a similar consideration applies to the other parameters on which the division may depend).

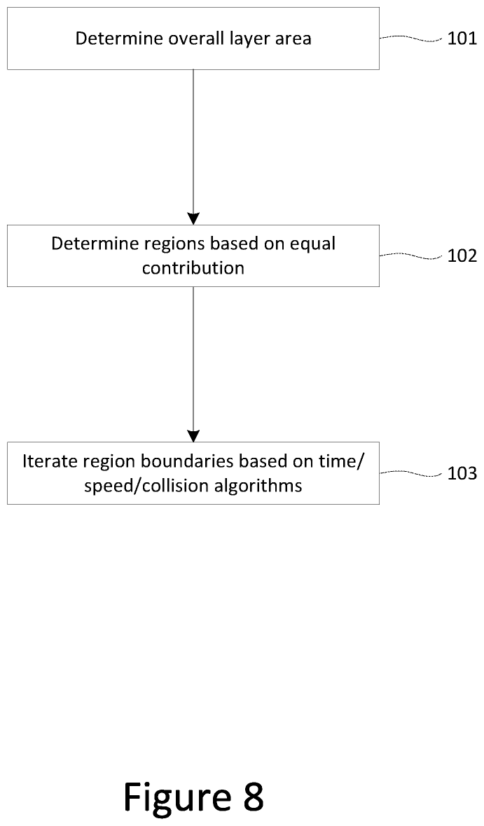

Region segmentations based on the above factors may be achieved in various ways; for example using algorithms, machine learning algorithms, artificial intelligence, and/or iteration. In some embodiments, the segmentation is achieved using iterative methods, where a computer device models and then modifies a segmentation in order to determine the segmentation that leads to minimum printing time. A method of achieving a minimum maximum-contribution segmentation is described below with reference to FIG. 8.

Typically, the segmentation of a layer is performed so that the length and/or the width of each region is equal to or greater than the minimum (allowable and/or possible) distance between two adjacent printer agents. This provides regions that are suitable for use as gaps; for example, with reference to FIG. 6b, the width of the region R(2,2) is set to be equal to or greater than the minimum distance between the nozzles A1 and A2 to ensure that nozzle A1 can work safely on region R(2,1) while nozzle A2 is working on region R(2,3).

In practice, the layer is typically divided into a number of macro-regions that is twice the number of printer agents in each row before each macro-region is divided into a number of regions that is a twice the number of rows of printer agents (and for one dimensional arrays only the first of these steps is required).

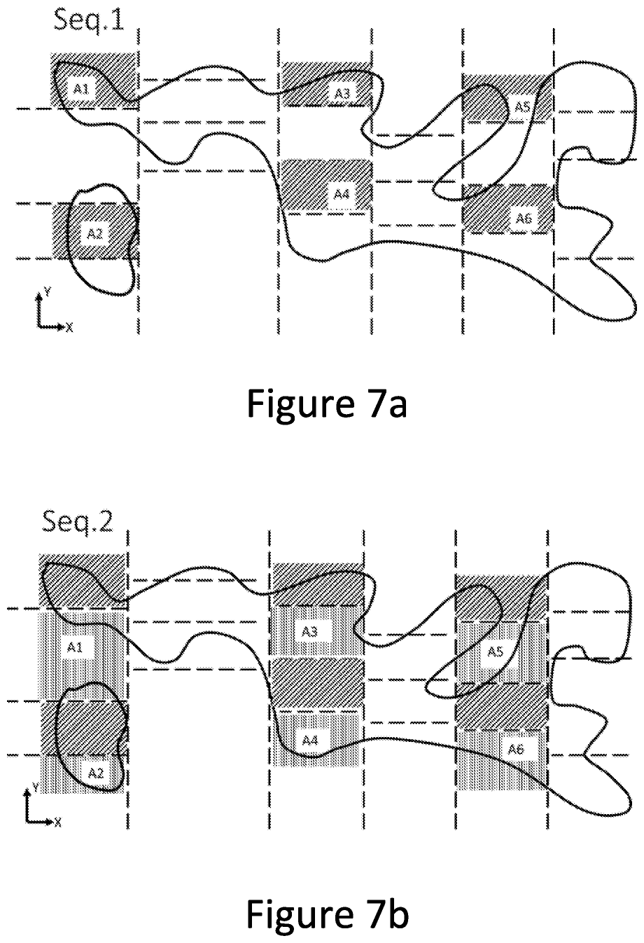

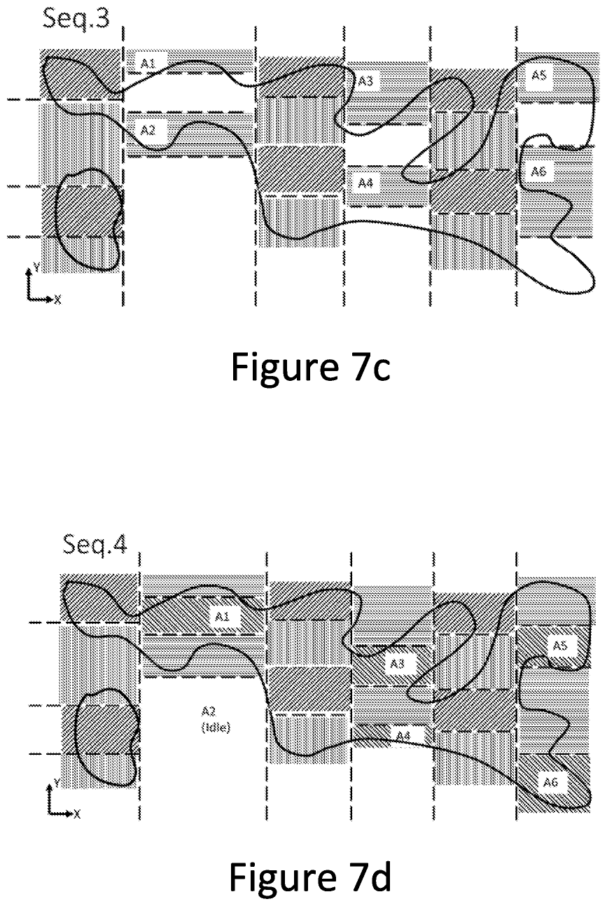

Referring to FIGS. 7a-7d, a method of forming/printing a layer based on the collection of regions is described.

The layer is formed using a number of printing steps, where FIGS. 7a-7d each illustrate the performance of one printing step.

During each printing step, each pair of adjacent printer agents only works on regions that are separated by a gap. In order to achieve this, each printer agent typically works on the same number of regions and each printer agent typically works (sequentially) on these regions. Where a printer agent is associated with four regions, the printer agent typically does not begin work on the second region until every printer agent has completed its first region. More generally, each printer agent is typically associated with a plurality of regions where a first printer agent is arranged to: complete a first region associated with the first printer agent, determine whether one or more (or all) other printer agents have completed first regions associated with said other printer agents; and begin work on a second region associated with the first printer agent in dependence on said other printer agents having completed work on said first regions associated with said other printer agents.

For a two dimensional array of printer agents, each printer agent typically works sequentially on four regions. In order to avoid conflicts between nozzles, each nozzle typically works in either a clockwise and/or a counter-clockwise order. For example, as shown in the example of FIGS. 7a-7d each nozzle may start work on a top-left region (from a plan view perspective), then move on to a bottom left region, then a bottom right region, then a top right region. More complex region ordering may also be used to minimise the time required to print a region (e.g. each printer agent may work on their largest region first and then move between regions in order of the time required to form those regions). This more complex ordering may be determined based on a user input and/or a machine learning algorithm.

A practical example is shown in FIGS. 7a-7d, which shows an example in which four sequential printing steps are used to form a layer. Considering the operation of nozzles A1, A2, and A3 during these steps:
At the first printing step, as shown in FIG. 7a:
   Nozzle A1 works on region R(1,1).
   Nozzle A2 works on region R(1,3).
   Nozzle A3 works on region R(3,1).
   Nozzles A1 and A2 are separated by the gap region R(1,2).
   Nozzles A1 and A3 are separated by the gap regions R(2,x) (e.g. separated by the second macro-region).
At the second printing step, as shown in FIG. 7b:
   Nozzle A1 works on region R(1,2).
   Nozzle A2 works on region R(1,4).
   Nozzle A3 works on region R(3,2).
   Nozzles A1 and A2 are separated by the gap region R(1,3).
   Nozzles A1 and A3 are separated by the gap regions R(2,x) (e.g. separated by the second macro-region).
At the third printing step, as shown in FIG. 7c:
   Nozzle A1 works on region R(2,1).
   Nozzle A2 works on region R(2,3).
   Nozzle A3 works on region R(4,1).
   Nozzles A1 and A2 are separated by the gap region R(2,2).
   Nozzles A1 and A3 are separated by the gap regions R(3,x) (e.g. separated by the third macro-region).
At the fourth printing step, as shown in FIG. 7d:
   Nozzle A1 works on region R(2,2).
   Nozzle A2 is idle (since region R(2,4) is empty).
   Nozzle A3 works on region R(4,2).
   Nozzles A1 and A2 are separated by the gap region R(2,3).
   Nozzles A1 and A3 are separated by the gap regions R(3,x) (e.g. separated by the third macro-region).

During each printing step there is a minimum gap maintained between pairs of adjacent printer agents in order to avoid collisions. The use of such gaps is optional—and in some embodiments instead of leaving gaps, the path of each printer agent is calculated to ensure that no collisions occur—however, typically gaps are used because by providing a gap the complexity of the required calculations is reduced since the operation of each printer agent in its region can be set entirely independently of the other printer agents. Furthermore, using gaps as described provides an additive manufacturing system that is resistant to errors of individual printer agents (e.g. if a printer agent becomes stuck in place during one of the printing steps it is not at risk of being impacted by an adjacent printer agent).

This process for printing a layer is then repeated for each layer in order to print a part.

Referring to FIG. 8, there is shown an exemplary method that may be used to determine the macro-regions and/or regions.

In a first step 111, the computer device determines an overall layer area.

In a second step 112, the computer moves left to right (or top to bottom) through the layer in order to divide the layer into macro-regions. Typically, the computer device is arranged to determine the macro-regions so that each printer agent has an equal contribution (e.g. prints the same amount of material and/or prints for the same amount of time). This may comprise determining the macro-regions so that each printer agent will print the same amount of material and/or so that each printer agent will move the same distance.

More specifically, the second step 112 typically comprises the computer device dividing the overall layer area by the number of agents in order to determine a target area for each agent. The division of the layer into the macro-regions is then dependent on the amount of material assigned to each agent being equal to this target area (or as close to this target area as possible given the arrangement of the printer agents and the requirement to maintain a separation between the printer agents throughout the printing process).

In a third step 113, the computer device repositions a macro-region boundary for the first printer agent based on time/speed/collision algorithms. This process is then repeated for each other printer agent. Typically, this is an iterative process, so that the computer device cycles through the nozzles and repositions the macro-region boundaries until no more changes are found to be necessary/beneficial.

The repositioning is typically dependent on one or more of:
The area of material assigned to the printer agent being equal to the target area (e.g. if the printer agent being considered has a current area of material that is less than the target area then the boundary may be repositioned to increase the assigned area of material).
The hardware and/or software limitations of the printer agent (e.g. the printer agent is typically only able to work within a certain workspace, where this may prevent the area assigned to the printer agent form being equal to the target area).
A dimension (e.g. the width) of each macro-region being greater than a threshold value. In particular, the width may be required to be greater than a minimum possible distance between printer agents so that each macro-region is able to act as a gap between adjacent regions (as described above). This dimension typically limits repositioning based on the above factors—e.g. the dimension is typically kept above the threshold value even if this results in the assigned area of material being different to the target area.

As mentioned, the method of dividing the layer into macro-regions is typically an iterative process. For example, in a first step the layer is divided into six equal macro-regions. The computer device then moves left to right through the layer and, at each boundary between two macro-regions, determines whether the amount of material in each of these two macro-regions is equal. If the amount of material is not equal, then the computer device shifts the boundary (and thus the regions) to achieve equality—or as close to equality as possible given the restrictions in workspace of each of the printer agents. This process may continue (with the computer device repeatedly iterating over the macro-regions) until the boundaries no longer change. It will be appreciated that this process may occur in any direction and with any starting point (e.g. it may go top to bottom or left to right).

This process can then be repeated to divide the macro-regions into regions. For example, for each of the macro-regions the computer device divides that macro-region into four equal regions. The computer device then moves from top to bottom through each macro-region and, at each boundary between two regions, determines whether the amount of material in each of these two regions is equal. If the amount of material is not equal, then the computer device moves the boundary (and thus the regions) to achieve equality—or as close to equality as possible given the restrictions in workspace of each of the printer agents. This process may continue (with the computer device repeatedly iterating over the regions) until the boundaries no longer change.

The computer device may arrange the macro-regions and/or the regions based on one or more of: the amount of material in each region begin equal; a path required to print the material in each region being equal; a maximum dimension (e.g. length) of a region being beneath a threshold value; the maximum contribution of a print head begin minimised; and the maximum printing time of a printer agent being minimised. Each of these parameters may be relevant for the determination of the entire printing process (e.g. so that each printer agent prints a near-equal amount of material overall) and/or relevant for the determination of each printing step (e.g. so that at each step each printer agent prints a near-equal amount of material).

Typically, the regions are determined so that a single printer agent is able to print an entire region. In other words, typically each region is determined to be located entirely within the workspace of a single printer agent (and a region may be located within the workspace of more than one printer agent; for example, a region may be located in the intersection between the workspaces of two printer agents so that either of these printer agents is able to form material within that region).

While the previous example has considered a grid arrangement of printer agents, and more specifically an arrangement with two rows of three nozzles, it will be appreciated that more generally any arrangement of printer agents may be used in which at least one pair of printer agents has intersecting workspaces.

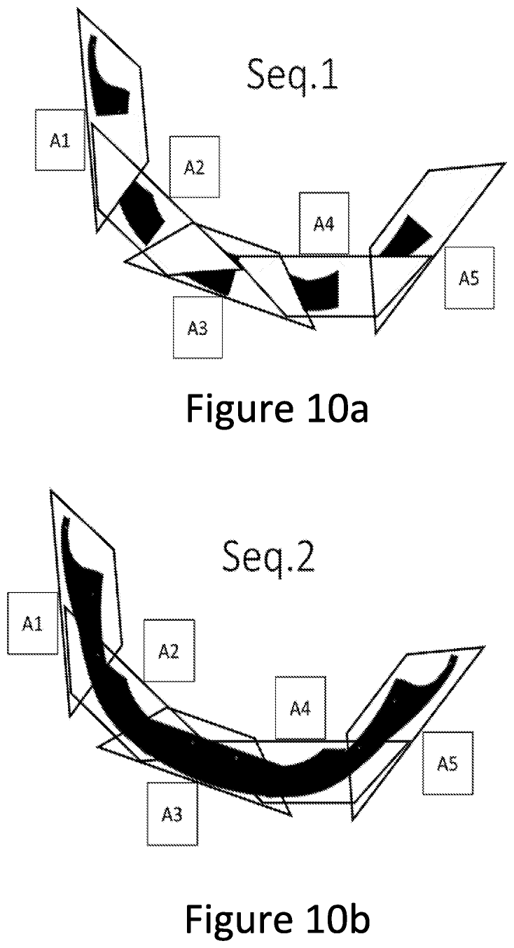

Referring to FIGS. 10a and 10b there is shown an implementation in which five printer agents (A1-A5) are arranged so as to have intersecting trapezoidal workspaces.

The additive manufacturing system 1 may be provided so that the printer agents are rearrangeable and/or reconfigurable, where this enables efficient printing for a wide variety of shapes. The additive manufacturing system (and/or a separate computer device) may be arranged to determine an optimal configuration of print heads, e.g. before a layer is divided into regions and/or before a part is divided into regions. In this regard, the division of a part into layers and the determination of the regions for each layer typically occurs before printing starts. The determination of an optimal configuration may occur using an iterative search and/or the method may comprise determining an optimal configuration out of an input set of possible configurations (e.g. this set may include a grid arrangement, a straight line arrangement, a curved line arrangement, etc.). The optimal configuration is typically the arrangement that minimises the printing time and/or minimises the average maximum contribution of a nozzle (over all of the layers of a part).

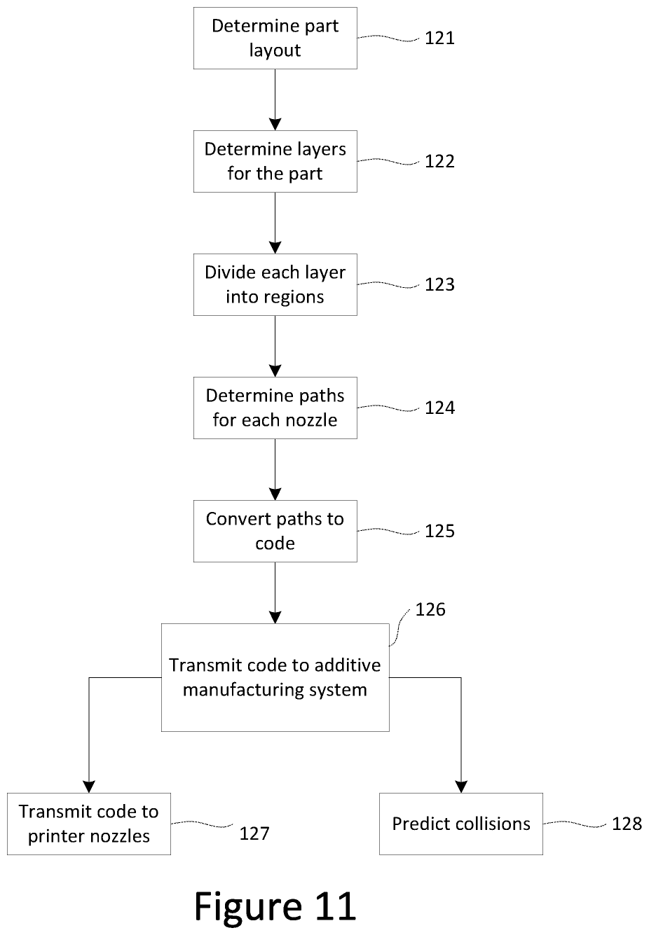

Referring to FIG. 11, there is described a detailed exemplary method for operating the additive manufacturing system 1. This method is typically carried out by a computer device, where certain aspects of the method may be carried out by the additive manufacturing system 1 and certain aspects may be carried out by a separate computer device.

In a first step 121, the computer device determines the layout of a part. In particular, the computer device may receive a file, such as a STL file, that describes the geometry of the part.

In a second step 122, the computer device determines layers for the part. This comprises slicing the part into layers that can thereafter be formed using the printer agents. The properties of the layers (e.g. the thickness of each layer) may depend on the material being used, the capability of the printer agents, the geometry of that layer, and/or a user input.

In a third step 123, the computer device divides each layer into regions. An exemplary method for dividing a layer into regions has been described above.

Dividing each layer into regions typically comprises dividing each layer into regions so that the printer agents each have an equal contribution (e.g. print the same amount of material) or have as close to an equal contribution as is possible based on the workspaces of the printer agents.

In a fourth step 124, the computer device determines paths for each nozzle based on the regions. This fourth step typically involves determining a sequence in which the nozzles should print each of their assigned regions. This fourth step typically further comprises determining a path for each nozzle with these regions.

In a fifth step 125, the computer device converts these paths into code and in a sixth step 126 the computer device transmits the code to the additive manufacturing system. Typically, this comprises transmitting the code to the master controller 2002 of the additive manufacturing machine where, in a seventh step 127, the additive manufacturing machine then sends relevant parts of this code to the individual printer agents.

The master controller 2002 may evaluate the code in order to determine which parts of the code should be sent to which nozzle. In an eighth step 128, the master controller may also evaluate the code in order to predict collisions between printer agents. In this regard, the methods disclosed herein may be used with a range of different additive manufacturing systems and configurations, therefore the master controller may check for collisions based on the received code as well as the configuration of the additive manufacturing system. For example, the additive manufacturing system may be useable with a variety of different sizes of printer agents, where certain code might be suitable for a first size of nozzle but might cause collisions if a second size of nozzle is being used.

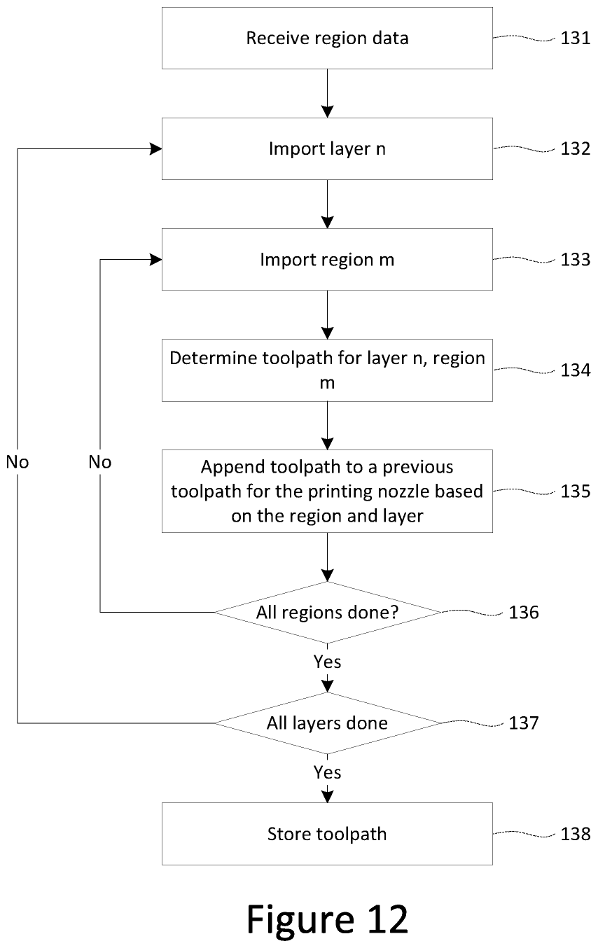

Referring to FIG. 12, there is described a method of determining paths for the printer agents (e.g. the fourth step 124 of the method of FIG. 12). This method is typically carried out by a computer device such as a computer device of the additive manufacturing system 1.

In a first step 131, the computer device receives region data associated with one or more layers of a part. This region data can be stored in the memory 1008 of the computer device prior to processing. This first step of the method of FIG. 12 may follow the third step 123 of the method of FIG. 11.

In a second step 132, the computer device imports a layer n of the part and in a third step 133 the computer device imports a region m of that layer n.

In a fourth step 134, the computer device determines a toolpath for the region m of the layer n. Typically, this comprises determining a path of minimum time for a printer agent to print the material in the region m of the layer n.

In a fifth step 135, this toolpath is appended to a previous toolpath for the printer agent.

In a sixth step 136, the computer device determines whether a toolpath has been determined for each of the regions of the layer n and, if it has, then in a seventh step 137 the computer device determines whether a toolpath has been determined for each of the layers of the part.

Once a toolpath has been determined for all of the regions of all of the layers, then in an eighth step 138 the toolpath is stored. This process may be repeated for each of the printer agents.

In this way, a toolpath is built up for each of the printer agents, with the computer device moving through each region of the part and appending a toolpath for each region to a master toolpath. The toolpaths may be determined sequentially, where the master toolpath for the first printer agent 2 is determined before the master toolpath for the second printer agent 4 is determined. Equally, the toolpaths may be determined near-simultaneously, where a toolpath is determined for each of the printer agents for each region and/or layer before the computer device moves onto the next regions and/or layer.

The determination may be an iterative process, where the computer device determines a toolpath for the region m of the layer n for the first printer agent 2, then determines a toolpath for the region m of the layer n for the second printer agent 4, then determines whether the toolpath for the first printer agent should be modified in light of the toolpath for the second printer agent. This method of iterative determination is particularly useful where there are no gaps between regions and where the independent determination of toolpaths may lead to collisions between printer agents. However, as has been described above, typically a gap is provided between the regions being worked on at any printing step; this enables the toolpaths to be determined independently since the gaps prevent collisions.

The example of FIG. 12 describes an embodiment in which a toolpath is determined for each printer agent, which toolpath includes all regions and all layers. It will be appreciated that a toolpath may instead be calculated for a smaller number of regions and/or layers.

In some embodiments, the toolpath for a layer n is determined only after the printing of an earlier layer (n-k), where k may be dependent on a user input, or dependent on a geometry of the part being printed. For example, the computer device may continuously determine toolpaths for the next ten layers to be printed (and the computer device may continuously update a buffer of the additive manufacturing system 1 to store these toolpaths). Such a method of determining the toolpath enables the computer device to respond to changes in the status of the additive manufacturing system 1. For example, if one of the printer agents malfunctions, the computer device may be able to identify this malfunction and to segment subsequent layers so as to minimise the usage of the malfunctioning printer agent.

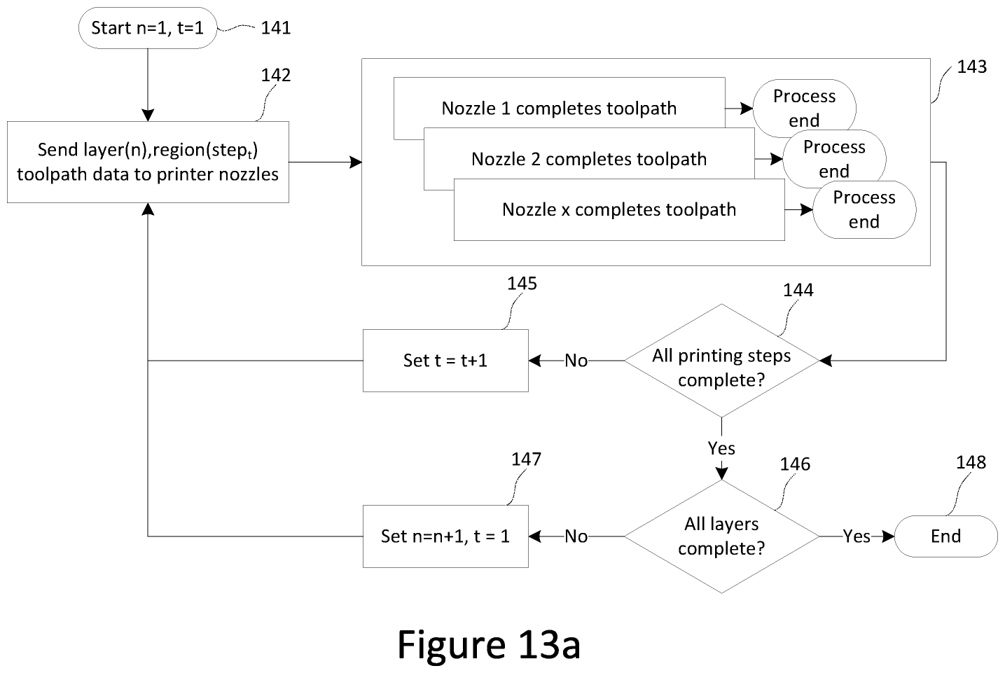

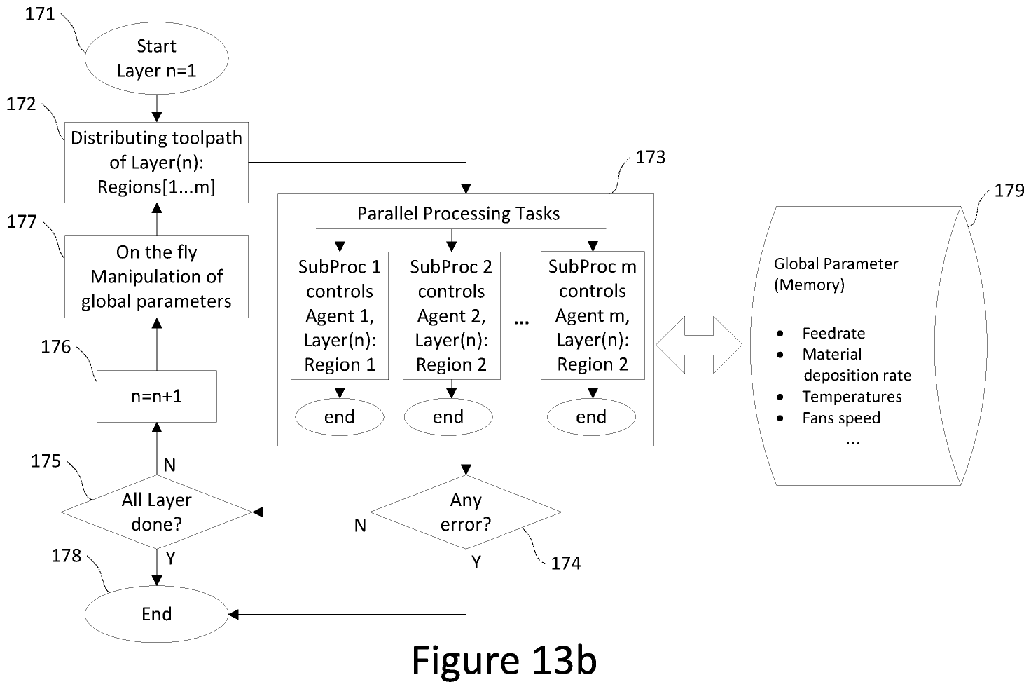

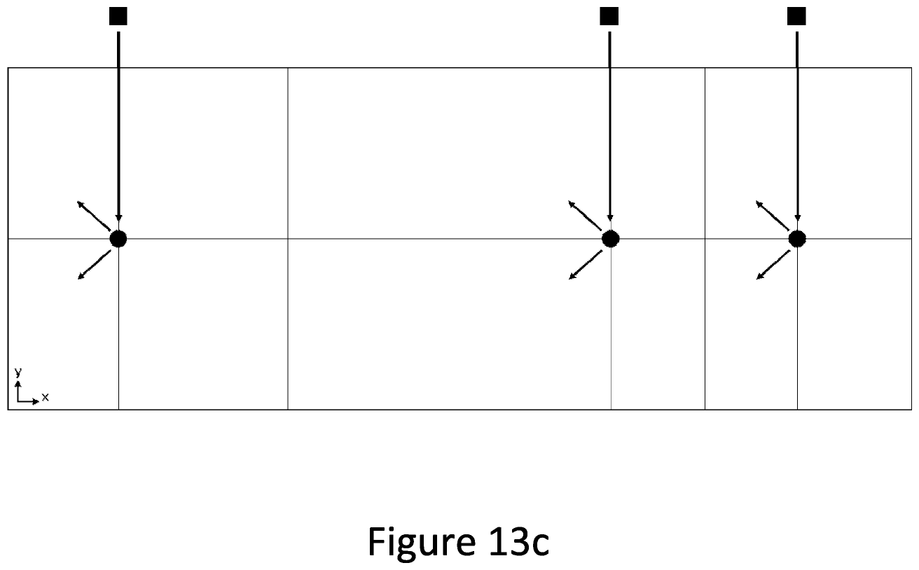

Referring to FIG. 13a, there is described a method of printing a part that may be performed by the additive manufacturing system 1. In particular, the additive manufacturing system may comprise a coordinator (e.g. a coordinating computer device) that is arranged to ensure that each of the individual printer agents is working on the correct printing step at all times. In this regard, as has been described with reference to FIGS. 7a-7d, the printer agents typically print a layer by performing a plurality of sequential printing steps, where each printer agent works on a specific region during each printing step.

In a first step 141, the method starts. At the start of the method, the coordinator sets the layer to be the first layer (so n=1) and the step to be the first step (so t=1). Step here refers to the printing step for a given layer, so referring again to FIGS. 7a-7d, where a two dimensional printer array is used there might be four steps for a given layer.

In a second step 142, the coordinator sends toolpath data for the current step of the current layer to each of the printer agents. The controller may transmit instructions to the printer agents prior to each step to ensure that the nozzles are always working on the correct region and to ensure that no collisions occur due to the nozzles losing coordination. It will be appreciated that other implementations are possible, for example toolpath data for a whole part may be sent to the printer agents at the start of the method and the second step may comprise the coordinator sending an instruction to execute the toolpath data for the current step of the current layer.

In a third step 143, each of the printer agents completes the toolpath associated with the received toolpath data. Typically, the printer agents complete their respective toolpaths simultaneously.

Each printer agent sends a completion notification to the coordinator when it has finished its toolpath; this enables the coordinator to determine when the printing step has been finished. For a given printing step, the printer agents may each print different amounts of material and may each finish printing at a different time. The coordinator is used to ensure that a printer agent does not move on to the next printing step t+1 until all other printer agents have completed their toolpaths for the printing step t (which would risk a collision).

In some embodiments, one or more printer agents may be arranged to move on to a second printing step while other printer agents are still completing a first printing step. In such embodiments, the coordinator may be used to determine that this is safe. For example, if a printer agent at the far left of the additive manufacturing system 1 is the only printer agent still on the first printing step then the printer agents at the right of the additive manufacturing system may be able to begin their second printing steps before this far-left printer agent has completed its first printing step.

In a fourth step 144, once the coordinator has received completion notifications from each of the printer agents, the coordinator determines whether all of the printing steps for the current layer have been completed. If they have not, then in a fifth step 145, the coordinator increments the printing step and the coordinator then returns to the second step 142 and sends the next batch of toolpath data.

Once all of the printing steps for a layer have been completed, then in a sixth step 146, the coordinator determines whether all of the layers have been completed. If not all layers have been completed, then in a seventh step 147, the coordinator increments the layer and resets the printing step to t=1.

Once all of the layers have been completed, then in an eighth step 148 the printing process ends. This may involve a completion notification being transmitted to another device to confirm that the part has been printed.

Referring to FIG. 13b, there is shown another method of printing a part using printer agents that are arranged to process instructions in parallel. It will be appreciated that the steps described with reference to the methods of FIGS. 13a and 13b may be used in any combination.

In a first step 171, the method starts. At the start of the method, the coordinator of the additive manufacturing system sets the layer to be the first layer (so n=1).

In a second step 172, the coordinator sends toolpath data for the current layer to each of the printer agents (e.g. the coordinator sends a toolpath to each of the printer agents that is determined based on the regions determined for that printer agent).

In a third step 173, each of the printer agents performs the toolpath associated with the received toolpath data so as to deposit material and to form a layer of the part. Typically, the printer agents complete their respective toolpaths simultaneously (and/or independently). Typically, the printer agents complete independently toolpaths associated with layers completed during the same step. That is, the printer agents may complete independently respective toolpaths associated with a first set of regions for a layer and then pause before completing simultaneously a set of toolpaths associated with a second set of regions for that layer.

The performance of the toolpaths typically depends on a set of global parameters 179 that are provided to the printer agents by a central control unit (this may be the coordinator that distributes the toolpaths and/or may be a different control unit). Typically, the central control unit is arranged to update parameters for each of the printer agents, where each of the printer agents may be associated with different parameters.

Once the printing of the layer is complete, in a fourth step 174 the computer device (e.g. the additive manufacturing system) determines whether there have been any errors. If there have been errors during a printing step, then the printing process ends 178 so that a user may troubleshoot the errors. In some embodiments, the errors may be assessed for each printer agent independently so that a user is able to troubleshoot an error associated with a single one of the printer agents while the other printer agents continue to deposit material.

In a fifth step 175, the computer device determines whether all of the layers of the part have been printed. If so, then the printing process ends 178. If not, then in a sixth step 176, the computer device increments a layer counter.

In a seventh step 177, the computer device manipulates the global parameters 179 that define parameters for the printing of the layer (that is about to be printed). The method then returns to the second step 172, and distributes toolpaths for the new layer.

In general—and in embodiments including or not including the other steps of the method of FIG. 13b—the computer device may be arranged to alter a set of (e.g. global) parameters in between the printing of layers of the part and/or in between the printing of sets of regions in a layer of the part. This enables the coordinator to manipulate these parameters on the fly. The manipulation of the parameters may depend on a change in the requirements and/or may be a reaction to the printing of a layer, where, for example, a user may set the first layer of a part to print slowly and may then increase the printing speed for subsequent layers when they have ensured that the first layer has printed as desired. The parameters are typically alterable by a user; the parameters may also be altered in dependence on an event or a sensor reading, so that the parameters for unprinted layers may be automatically updated based on the characteristics of already printed layers.

Typically, the parameters for the printer agents are defined before the printing of each region and/or layer and are then fixed during the printing of the regions/layers; this enables the printer agents to receive instructions regularly while still being able to print a region/layer without the need for a constant connection to the computer device. Furthermore, fixing the parameters during each printing step this reduces the chances of errors that could be caused by altering parameters during the printing of a region.

In some embodiments, the computer device is capable of altering the parameters for the printer agents during the printing of a region and/or layer. Such embodiments enable close control of the printing process and enable continuous adjustment of the printing process.

The parameters may include one or more of: a printing speed; a printing material; a material feed rate; a material deposition rate; a temperature (e.g. of the material, where the additive manufacturing system may comprise a heater to heat the material); a speed of fans (e.g. to cool the material after printing); a region size; and an overlap parameter.

The parameters may be altered for an individual printer agent and/or a group of printer agents. Typically, at least some of the parameters are global parameters that are set for all of the printer agents.

Referring to FIG. 13c, when a printer agent is not depositing material (e.g. if there is a printing step during which a printer agent has no material to deposit), the printer agent is typically placed in a standby position. In the standby position, the printer agent is typically spaced from the part to ensure that the standby printer agent does not interfere with active printer agents. For example, as shown by the squares of FIG. 13c, the standby printer agents may be located outside of the part and may then approach the part (move towards the circles) before starting the printing of a region.

Typically, each printer agent is arranged to return to a standby position after completing the printing of a region and/or a layer. Therefore, at the beginning of each printing step, each printer agent is in a (safe) standby position.

Typically, during a printing step the computer device is able to instruct a printer agent to pause and/or to move to a standby position. Due to the parallel processing provided by the disclosed system, such an instruction may be sent to a single printer agent so that maintenance can be performed on a single printer agent while the other printer agents are depositing material. This may be used, for example, to replace material associated with a printer agent without disrupting the operation of other agents.

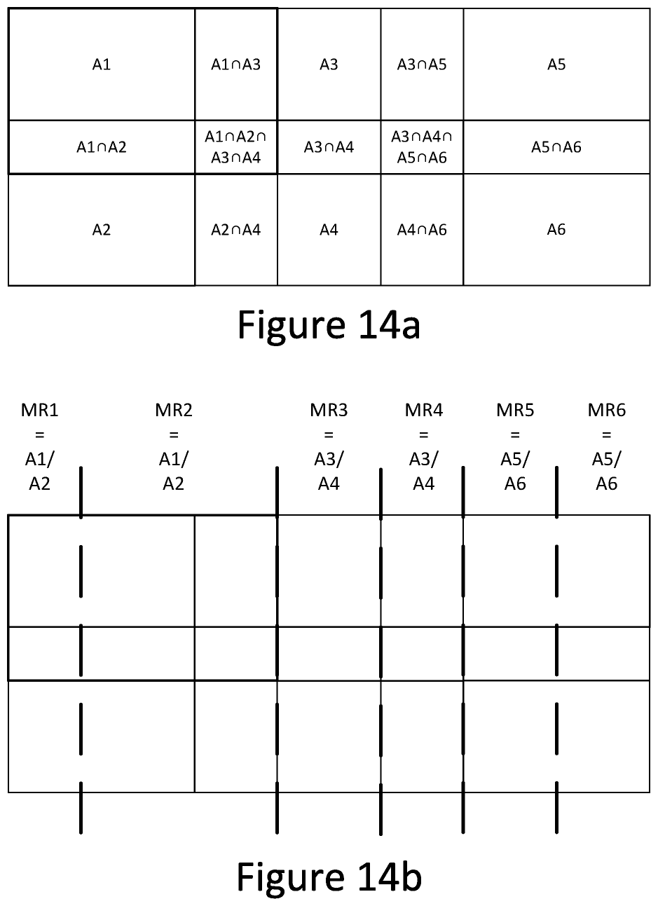

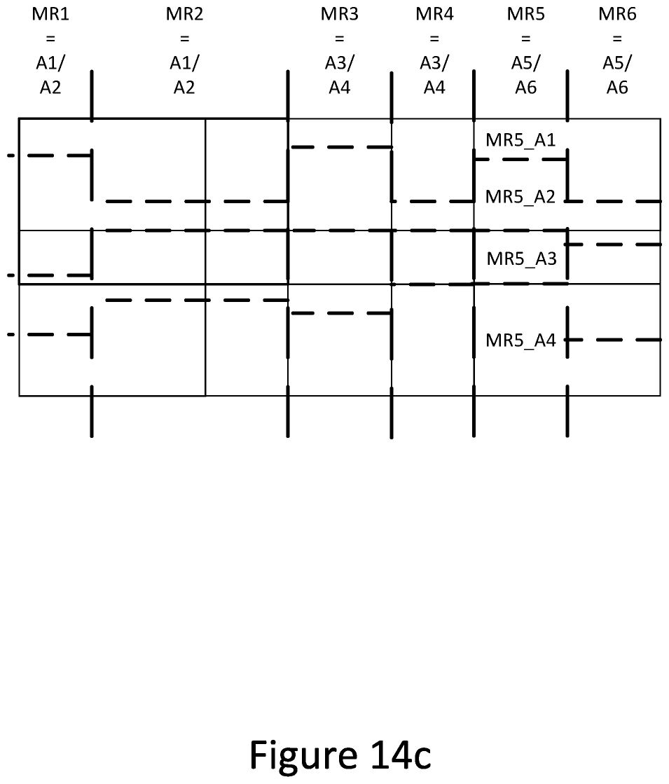

Referring to FIGS. 14a-14d, there is shown an illustration of the segmentation of a layer into regions.

FIG. 14a shows exemplary workspaces for an additive manufacturing system comprising an array of 6 printer agents (A1-A6) arranged in a 3×2 grid. In FIG. 14, the workspace of the printer agent A1 is outlined.

As shown by FIG. 14a, the additive manufacturing system may be arranged so that the workspaces of each pair of adjacent printer agents intersect (but typically so that these workspaces only partially intersect). Therefore, there exists:
A region in which only printer agent A1 is able to print.
A region in which both printer agent A1 and printer agent A2 are able to print.
A region in which both printer agent A1 and printer agent A3 are able to print.
A region in which each of printer agent A1, printer agent A2, printer agent A3, and printer agent A4 are able to print.

In order to form the regions for a layer, it is desirable that each region contains a similar amount of material and/or material associated with a similar printing time (e.g. the same length of toolpath). Typically, it is not possible to divide the material equally between printer agents due to the limited workspace of each printer agent; for example, for an exemplary layer the majority of the material may lie in the workspaces of printer agents A5 and A6 with only a small amount of material lying in the workspace of agent A1. In such a situation agents A5 and A6 are likely to need to print more material than agent A1—and so these agents may take longer to complete a region than the agent A1. The segmentation process typically seeks to minimise the total printing time.

Referring to FIG. 14b, the first step of the segmentation typically comprises dividing each of the workspaces into two macro-regions. Typically, the dividing of the regions is arranged so that each pair of opposing printer agents is associated with the same macro-regions (e.g. so that printer agents A1 and A2 is associated with the same macro-regions MR1 and MR2). By forming the macro-regions in this way, it is relatively straightforward to ensure that for each printing step there is a gap between the regions being worked on by these opposing printer agents. In some embodiments, the macro-regions for opposing printing agents differ; however, this increases the complexity of providing gaps between regions during printing steps and so increases the likelihood of a collision between printer agents.

The location/size of the macro-regions depends on the distribution of material in the layer, where the macro-regions are typically formed so that each macro-region contains a similar and/or the same amount of material.

More specifically, the computer device may be arranged to divide the layer into macro-regions so that each pair of opposing printer agents is associated with two macro-regions. The two macro-regions for each of these pairs may be determined so that each macro-region contains a similar and/or the same amount of material.

Since there is an intersection between adjacent workspaces (e.g. between A1/A3 and A3/A5), the size of the macro regions for each pair of opposing printer agents may differ (as shown in FIG. 14b where MR1+MR2 is bigger than MR3+MR4).

As described with reference to FIGS. 8 and 9, the boundaries of the macro-regions are typically arranged to result in equal amounts of material in each region (to the extent possible). In various embodiments, the computer device is arranged to determine regions to optimise for a variety of factors (e.g. minimum printing time, minimum movement of printer agents).

This division process can then be repeated to divide each macro-region into regions. The division of each of the macro-regions into regions is typically independent of the other macro-regions.

Typically, similarly to the division into macro-regions, the division into regions is determined based on the amount of material in each region, the time required to print each region, and/or the length of a toolpath in each region.

An exemplary division into regions is shown in FIG. 14c. As shown in this figure, each region is typically determined such that it is located entirely in the workspace of a single printer agent; for example, macro-region MR5 is divided into regions MR5_A1, MR5_A2, MR5_A3, MR5_A4. Regions MR5_A1, MR5_A2, and MR5_A3 are entirely in the work region of printer agent A5 and regions MR5_A3 and MR5_A4 are entirely in the work region of printer agent A6.

This method of division ensures that each printer agent is associated with four regions and that each printer agent can work simultaneously without risk of a collision. Specifically, each printer agent is associated with four regions set out in a grid and each printer agent is typically arranged to complete their regions in the same order (e.g. clockwise from the same starting region and/or in in the same pattern, such as top-left, bottom-right, bottom-left, top-right).

Typically, the material used for printing is such that the material printed by adjacent printer agents can be joined in a straightforward manner. For example, where the material used is a powder, two regions printed by different printer agents may be joined together using sintering in order to provide a single combined part. With certain materials and/or parts it may be desirable to print a part so that there is a spatial overlap in the material printed by two adjacent printer agents.

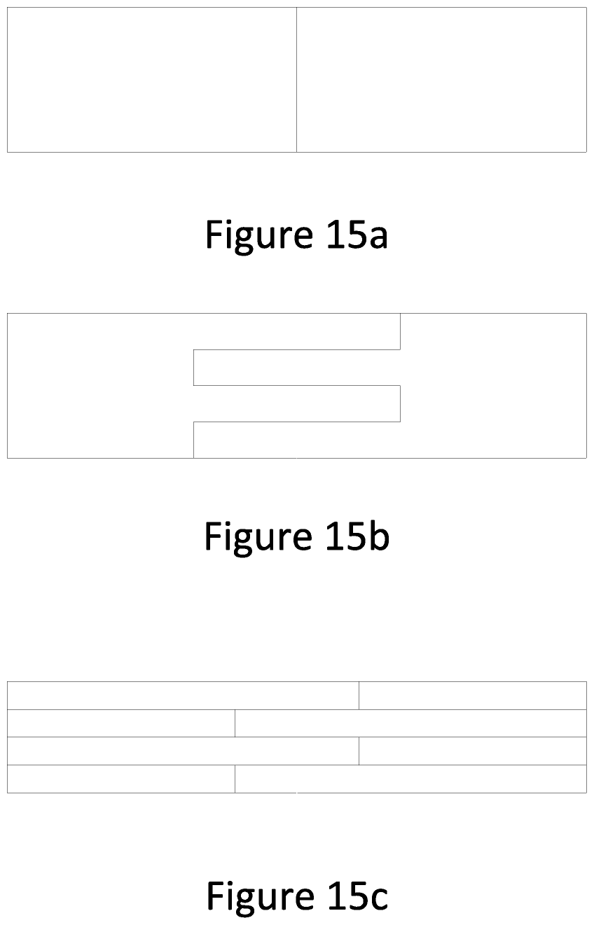

Referring to FIG. 15a, there is shown a plan view of an example of a boundary between two sub-parts, where each sub-part is printed by a different printer agent and where there is no overlap in the material printed by the adjacent printer heads.

Referring to FIG. 15b, there is shown a plan view of an example of a boundary between two sub-parts, where there is an overlap in the material printed by the adjacent printer heads for a single layer.

Referring to FIG. 15c, there is shown a side-on view of an example of a boundary between two sub-parts, where there is an overlap in the material printed by the adjacent printer heads for different layers.

Typically, the overlap comprises protrusions of one sub-part protruding into recesses of another sub-part. The protrusions may be raked in order to increase the contact surface area between the protrusions and the recesses and to ensure a tighter fit.

Where the overlap is located in a single layer, the overlap may be obtained by assigning two or more printer agents to the same region. Typically, these printer agents are assigned to work on this region during different printing steps. For example, with the example of FIGS. 7a-7d, the printer agent A2 may perform the first printing step of region R(1,3) so that there are recesses left in the sub-part printed in this region. The method of printing may then comprise a fifth printing step in which the printer agent A1 prints material in the region R(1,3) so that material protrudes from the region R(1,2) into the region R(1,3) and fills these recesses. This method of printing forms a tight fit between the material in regions R(1,2) and R(1,3) as shown in FIG. 15b while ensuring that there is still a separation between the printer agents during each printing step.

Equally, the method of assigning regions may determine the boundaries of the regions such that a region of a first layer printed by the first printer agent 2 overlaps with a region of a second layer printed by the second printer agent 4 (where the second layer is typically adjacent—e.g. immediately above or below—the first layer); this provides an arrangement as shown in FIG. 15c.

Achieving this overlap may comprise determining the regions in order to obtain the overlap and more specifically may comprise moving a boundary between regions of the second layer so as to obtain the overlap. Typically, the moving of this boundary occurs after the determination of the regions (and so the moving of the boundary may alter the contribution of each printer agent).

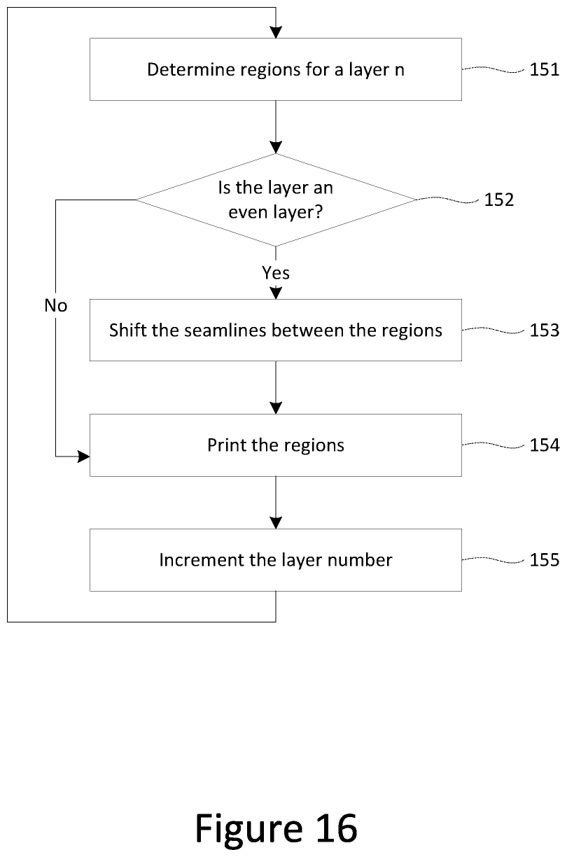

A method of providing an overlap is described with reference to FIG. 16. This method is typically implemented by the computer device that is determining the regions.

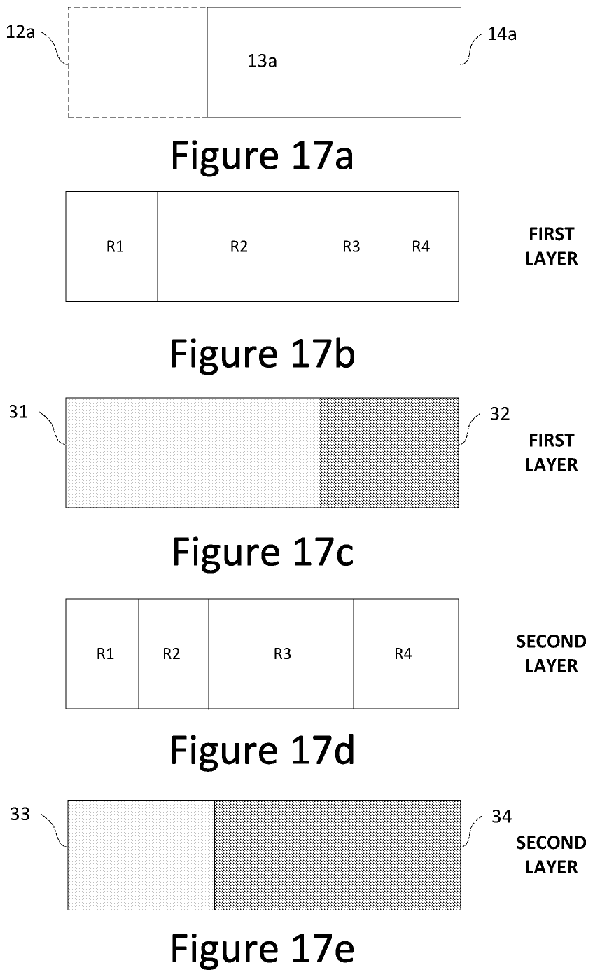

FIGS. 17a-17e illustrate an example of the implementation of the method of FIG. 16 for a system with a first printer agent and a second printer agent that have, respectively, a first workspace 12a and a second workspace 14a as shown in FIG. 17a. The first workspace and the second workspace intersect over an intersecting area 13a.

Referring to FIG. 16, in a first step 151, the computer device determines regions for a first layer. Methods of determining regions have been described previously, for example with reference to FIG. 8.

This determination may lead to the regions R1, R2, R3, and R4 shown in FIG. 17b. With this example, the entirety of the intersecting area 13a is assigned to the first printer agent as part of region R2. More generally, it will be appreciated that this intersecting area may be assigned in a variety of ways (e.g. a part of this intersecting area may be assigned to the first printer agent and the remainder may be assigned to the second printer agent).

In a second step 152, the computer device determines whether the layer is an even layer.

With the example of FIG. 17b, this layer is an odd layer, and so the computer device moves onto the fourth step 154.

In a fourth step 154, the printer agents print their assigned regions.

In a fifth step 155, the layer number is incremented and the method then returns to the first step 151. Therefore, the computer device determines regions for a second layer.

If the layer is an even layer, then in a third step 153, the computer device shifts the seamlines between the regions. More specifically, the computer device shifts the seamlines between regions so that a region in the first layer that is assigned to the first printer agent overlaps with a region in the second layer that is assigned to the second printer agent. This is shown in FIG. 17d, where it can be seen that region R3 of the second layer overlaps with region R2 of the first layer. FIG. 17e shows the second layer once it has been printed.

The method of FIG. 16 ensures that there is an overlap between adjacent layers of the part and so ensures a secure connection between the material printed by adjacent printer agents (e.g. via an interference fit and/or due to the overlapping material being bonded together using an adhesive or heat).

More generally, the second step 152 may comprise the computer device determining whether this layer is a multiple of a certain number and/or determining whether there has been an overlap of sub-parts within a certain number of preceding layers (e.g. if the last printed layer and the second-to-last printed layer overlapped then the computer device may not perform this second step). This ensures regular overlapping of parts.

The shifting of the seamline may occur following the determination of the regions and/or may be a part of the determination of the regions. In particular, the first step of the method of determining regions may comprise the determination of a seamline between each pair of printer agents where regions are then determined in dependence on this seamline. Returning to the example of FIG. 17d, the boundary between regions R2 and R3 may be determined as a first step and then the regions R1, R2, R3, and R4 (and in particular the boundaries between: R1 and R2, and R3 and R4) may be determined thereafter. This enables the regions for each printer agent to be determined in such a way as to equalise the contribution of each region (and/or to minimise the maximum contribution of any of the printer agents at each step) while still obtaining an overlap.

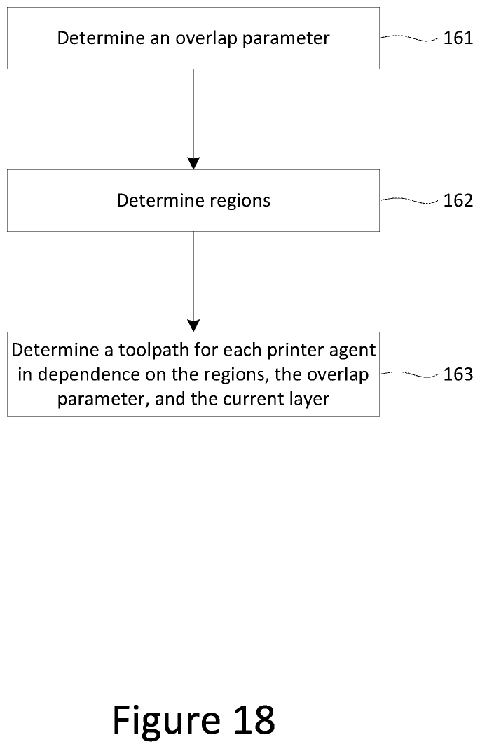

Referring to FIG. 18, a general method of determining (and outputting) an overlap is described.

In a first step 161, the computer device determines an overlap parameter. This parameter is typically entered by a user. Equally, the overlap parameter may be based on the material being printed, the part being printer, and the geometry of a region. For example, the overlap may be determined based on a strength requirement, where the strength of the printed part may depend on the material being used and the amount of overlap between layers.

In a second step 162, the computer device determines regions 162 for a layer. This may comprise determining regions as described above (e.g. regions with equal contribution). Equally, this may comprise determining regions using another method—and it will be appreciated that the disclosed methods of determining an overlap have broad applicability regardless of how the regions are determined. In a third step 163, the computer device determines a toolpath for each printer agent in dependence on the regions, the overlap parameter, and the current layer. In particular, the computer device determines a toolpath that achieves the determined overlap parameter. This may involve shifting the boundaries of the determined regions so that a toolpath can be formed that achieve the overlap parameter.

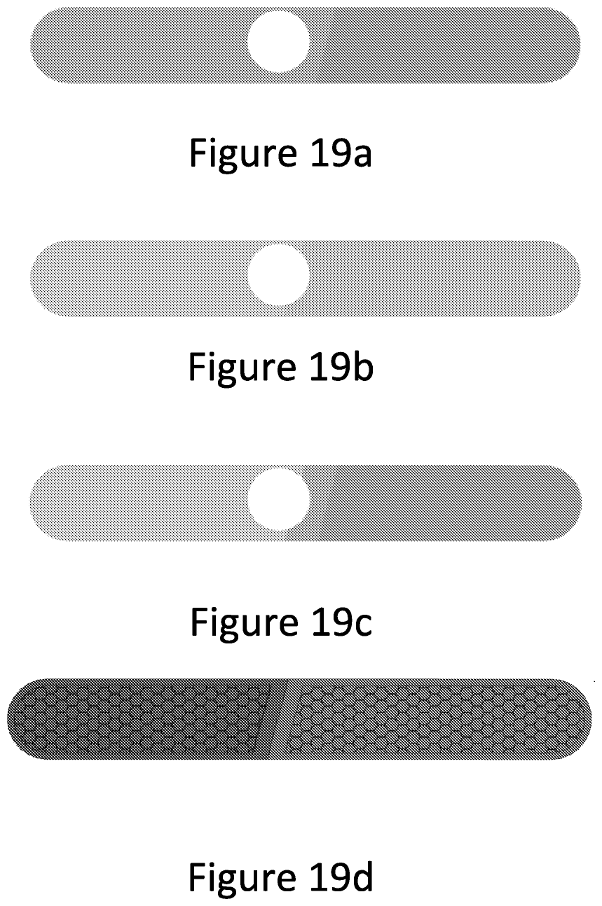

Referring to FIGS. 19a-19c, there is shown another example of the shifting of a boundary between regions in order to provide an overlap. Referring to FIG. 19a, an exemplary region division for odd layers is shown and referring to FIG. 19b an exemplary region division for even layers is show. This leads to the arrangement of FIG. 19c, where an overlapping area can be seen.

Referring to FIG. 19d, an example is shown where each of the printer agents is arranged to print their regions using a hexagonal infill. The printing of material at the boundaries of the region may use a similar structure, or may use a different structure so as to form a tight fit between layers.

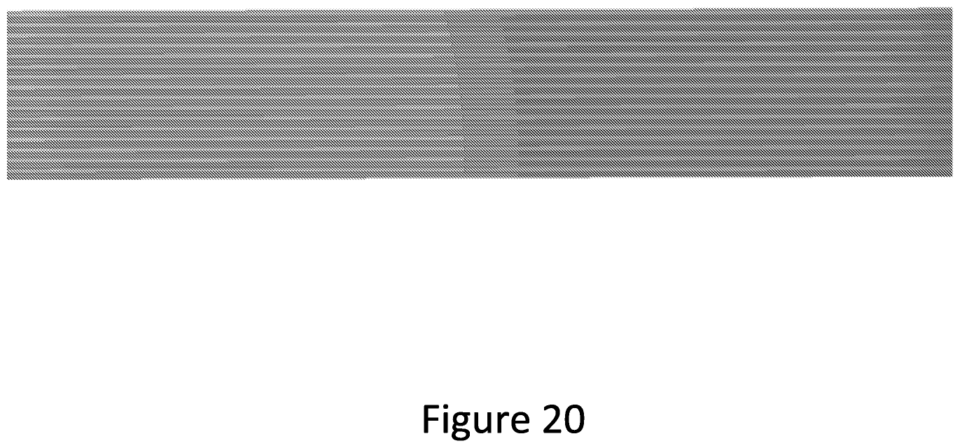

Referring to FIG. 20, there is shown a part comprising a plurality of layers, where it can be seen that there is an overlap between each pair of adjacent layers. This forms a ‘brickwork’ stack of layers so that there is a secure joint formed between the regions printed by adjacent agents. As can be seen in FIG. 20, the overlaps do not need to have a perpendicular profile when viewed from the side. The profile of the overlaps is typically dependent on the geometry of the part (where this geometry affects the determination of the regions as described above).

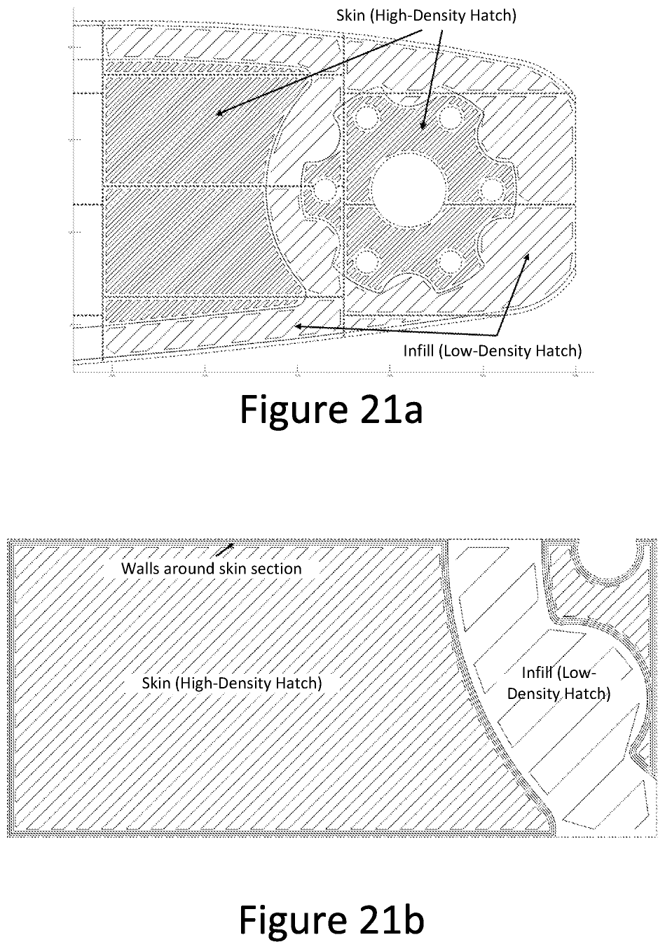

Referring to FIGS. 21a and 21b, there are shown examples of parts formed of different types of sections. In this regard, each part is typically formed of shell sections and core sections, where the shell sections are the outer sections of the part (e.g. external walls and/or those sections near the outside of the part) and the core sections are the sections that are internal to the shell sections. Typically, the shell sections are printed using a relatively high density material (or printing process) in order to provide good ceiling and surface roughness and to provide protection to the core parts, which core parts are printed using a relatively low density material (or printing process). The thickness of the shell sections may depend on the desired material properties and the intended use of a part.

Typically, the core sections are filled using a two-dimensional pattern, such as a grid or a gyroid. Such a pattern may be called an infill. The properties of the infill influence the mechanical properties of the part.

Furthermore, the part may comprise one or more skin sections (or skin layers), which skin sections are the topmost or bottommost layers or the part. The skin sections are a subset of the shell sections (being the horizontal sections at the top and bottom of the part, whereas the other shell sections are the vertical sections on the sides of the part). The part may also comprise one or more wall sections, which wall sections may be internal or external. The wall sections represent boundaries of polygons used to form the part and provide structural support to the part.

The computer device is typically arranged to differentiate between infill sections (and/or core sections) and skin sections (and/or shell sections). In order to achieve this, before determining (e.g. finalising) the regions for a first layer, the computer device may be arranged to identify an adjacent layer (or a plurality of adjacent layers). Skin sections can be determined as those sections without a threshold number of adjacent layers on one or both sides (e.g. the outermost skin layer will only be adjacent to another layer on one side). In contrast, infill sections have a larger amount of adjacent layers. It should be appreciated that since the additive manufacturing system may be used for parts of various geometries, it is possible that a single layer of a part may comprise both infill sections and skin sections.

Typically, the parameters for the printing of a region are defined based on a type of that region (e.g. whether the region relates to a core section or to a shell section). A computer device defining the parameters may then be arranged to determine a type of a region and to define one or more parameters for a printer agent associated with the region in dependence on the type of the region. The type may be one or more of: a shell section, a skin section, a core section, and an infill section. Typically, the computer device is arranged to define parameters for shell sections that lead to a high density region (e.g. by using a high density material and/or by printing a high density mesh) and/or to define parameters for core sections that lead to a low density region (e.g. by using a low density material and/or by printing a low density mesh).

FIGS. 21a and 21b shows cross-sections of arrangements of skin sections and infill sections. As can be seen in these figures, there are borders between adjacent infill sections and skin sections. In this regard, a (thin) wall can be used to increase the bonding between two sections which have a different density. Typically, this wall comprises a thin region with overlapping to guarantee that all beads of material that reach that area are well secured and protected.

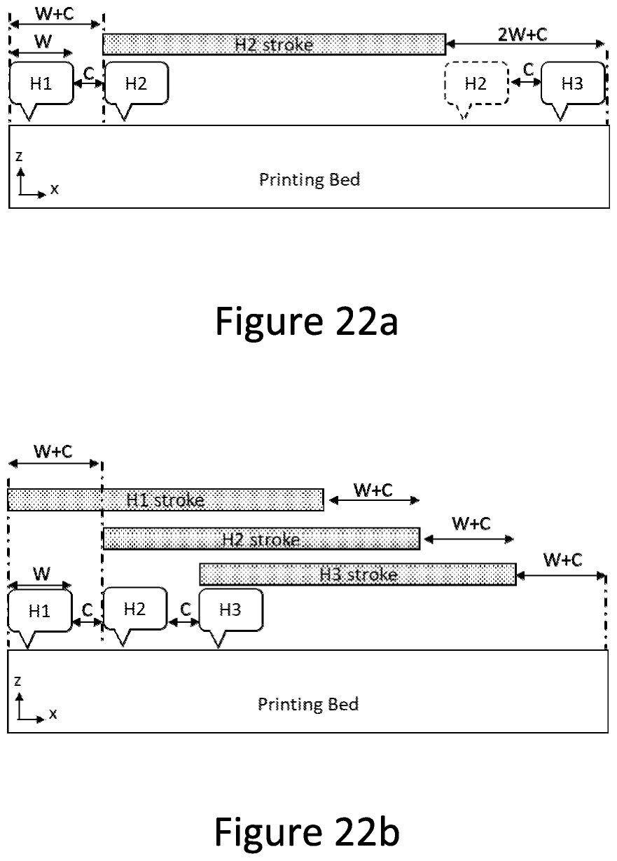

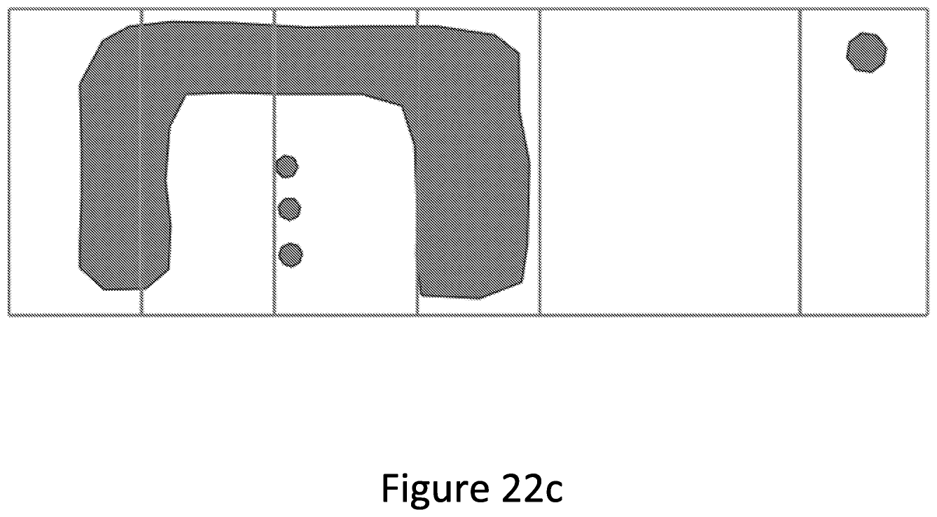

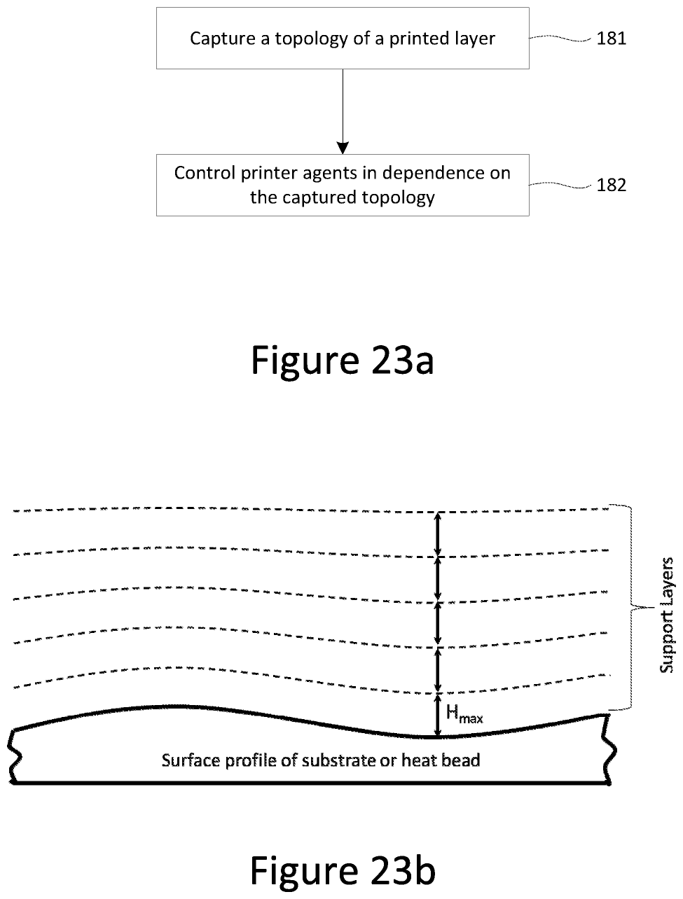

FIGS. 22a and 22b show an arrangement of three printer agents with different movement ranges. FIG. 22c illustrates a method of determining regions for a layer using the arrangement of FIGS. 22a and 22b.

As has been described above, the present disclosure considers a method of determining a plurality of regions for a layer, where the regions are determined in order to distribute the task of printing a layer equally between printer agents (e.g. so that each printer agent has an equal contribution).

In some embodiments, the printing time is determined by calculating a toolpath travelling time for each of the printer agents and by then altering the toolpaths to reduce the maximum travelling time (e.g. the travelling time of the printer agent with the largest travelling time). However, this can be computationally expensive and so in some embodiments alternate methods of determining the regions are used. In particular, since the area of each region is a reasonable estimation of the workload necessary to build a layer, the regions may be determined so as to minimise the area of the largest region (or to obtain regions with an area that is as close as possible to the total area of a layer divided by the number of printer agents). The ‘area’ may refer to the area of a region or to the area of material in a region, where regions may contain both material and empty space.

In some embodiments, as has been described above with reference to FIG. 9, the method of determining regions comprises dividing a layer into regions and then iteratively scanning through the layer and adjusting the regions so as to provide regions with similar amounts of material (e.g. the method may involve scanning left to right and then moving a boundary between each pair of adjacent regions based on which of these adjacent regions contains a larger area of material).

In the example of FIG. 9, the layer is divided into six regions which are suitable for three printing agents to print in two printing steps.

In some embodiments, as has been described above, a limited workspace for each printing agent can be defined in order to determine suitable regions. FIGS. 22a and 22b illustrate such workspaces for a linear arrangement of printer agents (e.g. where the printer agents are arranged to move along a gantry in order to deposit material).

Considering fixed-base stationary printer agents, the (safe) reachable area is equal to the agent's workspace. For a cartesian gantry machine in which the base of the agents is able to move along the gantry, as shown in FIGS. 22a and 22b, the reachable area for each printer agent is defined by a range of motion for each individual printer agent that is achievable while maintaining a minimum separation between said printer agent and any other printer agents. In some embodiments with movable printer agents, the workspace of each printer agent may be the entire build area (e.g. when each other printer agent is in a standby position). In other embodiments, the range of motion of a printer agent may be limited to a subset of the build area. FIGS. 22a and 22b show an arrangement with three printer agents; these figures show the reachable area of the printer agent H2 along the X-axis while the printer agents H1 and H3 are kept a minimum distance of C away from H2. It will be appreciated that the reachable area of a printer agent may be any shape, and this area may be a two-dimensional or three-dimensional shape.

As shown in FIGS. 22a and 22b, the minimum separation distance for a gantry-type additive manufacturing machine is typically set to be equal to the printer agent footprint width+the minimum allowable clearance between printer agents (W+C).

Considering the reachability constraints for the printer agents (e.g. bearing in mind the need to maintain a minimum separation of printer agents), a fully equal distribution of material between all printer agents may not be achievable. Therefore, as has been described above, the method of determining regions is typically arranged to minimise the contribution of the printer head with the maximum contribution.

In practice, this method of determining regions may comprise validating a pre-defined reachable area for each printer agent on each iteration. The method may then alter the regions in dependence on this pre-defined reachable area (e.g. to move a boundary line of adjacent regions as far as possible in a direction that minimises a maximum contribution). Where such a method is applied to the layer shown in FIG. 9 with the arrangement of printer agents shown in FIGS. 22a and 22b, the constraints caused by the limitations on the reachable areas of the printer agents may lead to the regions shown in FIG. 22c.

### Calibration and Error Compensation

In order to improve the accuracy of the additive manufacturing system, there are described herein methods of calibrating the printer agents as well as methods of compensating for inaccuracies in the printing of a region or compensating for characteristics of a substrate.

In some embodiments, in order to enable the additive manufacturing system to compensate for an intra-layer height difference, one or more of the printer agents comprises a height adjusting mechanism that allows said printer agent to alter the distance of said printer agent from a plane associated with the additive manufacturing system.

Typically, the additive manufacturing system is arranged to print a layer on a plane, where this plane may be considered using cartesian co-ordinates (e.g. using an x-y grid that is aligned with the plane). In such a situation, the printer agents may each be arranged to (e.g. independently) adjust their distance from this plane, e.g. to adjust their position in the z direction.

In other words, it may be possible to individually move the printer agents up and down to ensure that all the nozzle tips are located in the same plane (XY plane). For example, in a robotic assisted multi-head printing system, z-height adjusting can be achievable by moving the end-effector of each robotic printer agent up and down. In a gantry-based system, that enables the printer agents to move along the x-y plane via the gantry, each printer agent may then comprise a separate adjustment mechanism for enabling movement of that printer agent perpendicular to the gantry.

To enable accurate adjustment, each printer agent is typically associated with a height sensor that measures a distance of that printer agent from a plane of the additive manufacturing system.

Referring to FIGS. 23a and 23b, a method of compensating for a difference in the height of a bed of an additive manufacturing system, a substrate, and/or a printed layer. This method is typically carried out by a computer device (e.g. the additive manufacturing system).

In a first step 181, the additive manufacturing system captures a topology of a bed of the additive manufacturing system, of a substrate on which a layer is to be printed, and/or of a printed layer. This may comprise capturing the topology using the height sensors of one or more of the printer agents and/or using a separate height sensor (and optionally interpolating between height measurements). This topology may then be stored by the computer device as a matrix or a mesh.

Measurements associated with the captured topology are then applied to each of the printer agents. This allows each printer agent to use the same topology and coordinate system for height adjustment of a subsequently printed layer.

In a second step 182, as the printer agents print regions, a controller of the additive manufacturing system adjusts the heights of one or more of the printer agents based on the captured topology; typically the controller adjusts the heights of the printer agent so as to maintain a constant separation between each printer agent and the substrate and/or the previously printed layer.

In some embodiments, the controller adjusts the heights of the printer agents so as to decrease an intra-layer inconsistency in height. This may comprise reducing the height of a printer agent and/or reducing the amount of material deposited by a printer agent when the printer agent is adjacent a raised region of the previously printed layer.

In this regard, as shown in FIG. 23b, the early layers at beginning of the printing process are usually used as a support layer and the compensation algorithm described above can be used to gradually compensate for a straightness error or a flatness error of a substrate or a bed of the additive manufacturing system. FIG. 23b shows how such a method can be used to adjust the layer thickness between subsequent layers to eventually achieve a desired flatness on the top layer of a support structure. Typically, the computer device is arranged to ensure that a layer thickness at each point of each layer is equal to or less than a nominal layer thickness all along the profile of a part in order to guarantee a strong bond between layers. Hmax, as shown in FIG. 23b, is a maximum layer thickness, where the controller is typically arranged to ensure this maximum layer thickness is equal to or less than a nominal layer thickness.

For simplicity, FIG. 23b shows how the error compensation may be applied along a single axis; it will be appreciated that typically such error compensation is applied across a two-dimensional plane.

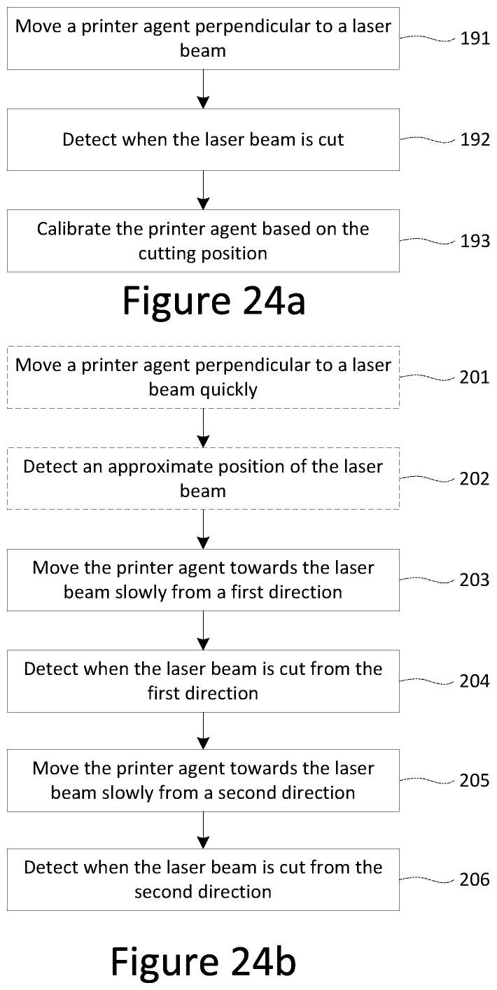

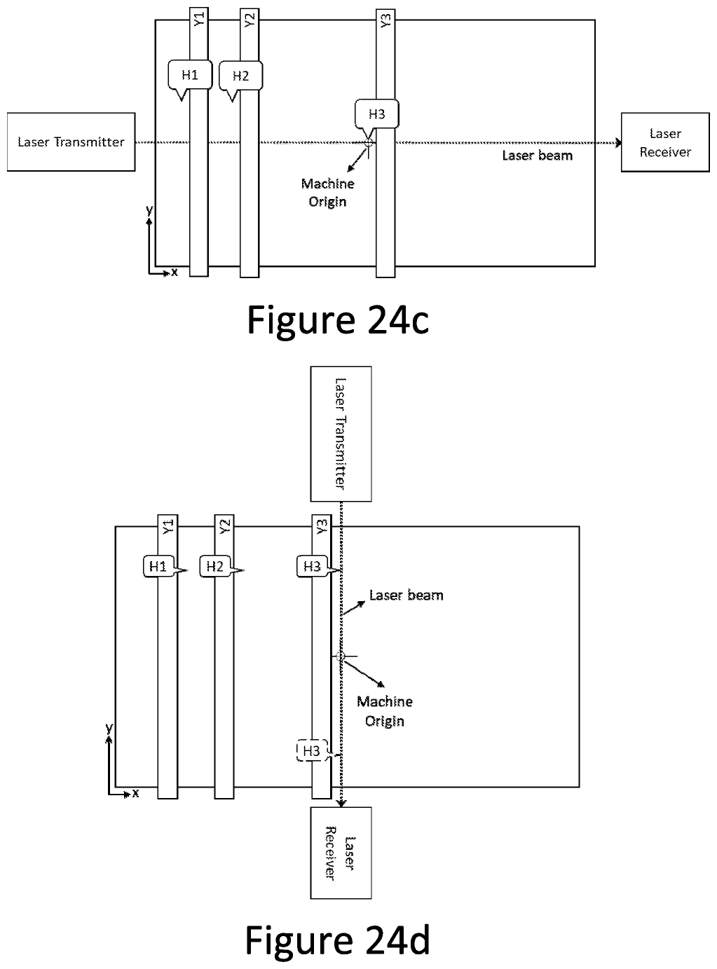

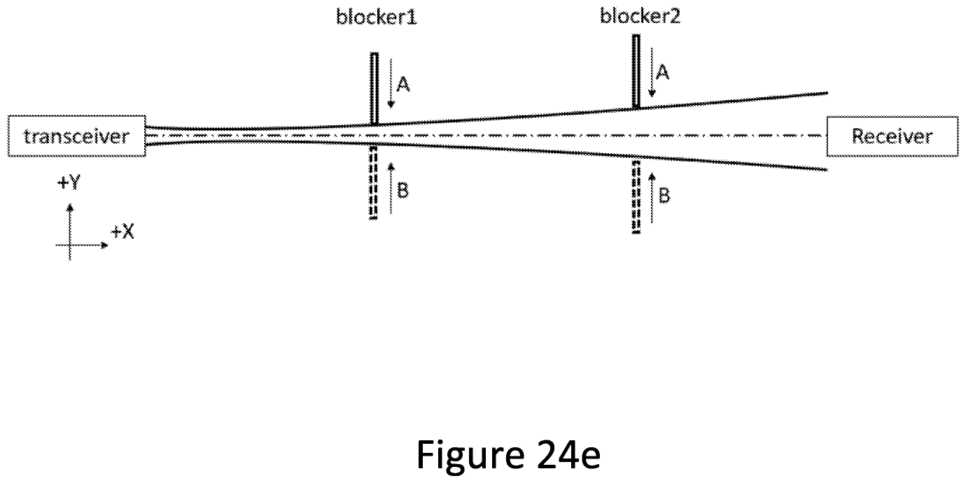

FIGS. 24a-24e illustrate arrangements for, and methods of, calibrating the printer agents.

The starting positions of the printer agents depend on the features of the additive manufacturing system and these positions may change over time as components of the additive manufacturing system undergo wear and tear (e.g. errors may be introduced due to deviations in the straightness of a rail of a gantry and/or due to a deviation away from parallelism of two rails of a gantry). Therefore, the present disclosure considers methods of calibrating the printer agents to ensure that the printer agents are accurately positioned before the performance of the printing steps.

In particular, the present disclosure considers the use of a linear laser beam as a refence line for ensuring each of the printer agents has a consistent datum in a direction perpendicular to the laser beam.

FIGS. 24c and 24d show arrangements of additive manufacturing systems that comprise laser arrangements for calibrating printer agents along the axes of a cartesian grid. It will be appreciated that similar arrangements could be used for various arrangements of printer agents.

In these arrangements, a laser beam transmitter and a laser beam receiver are arranged so that one or more printer agents are able to move between the transmitter and the receiver. The printer agents are typically arranged to move perpendicular to the direction of the laser beam.

Typically, the additive manufacturing system comprises a plurality of (e.g. two and/or three) pairs of laser beam transmitters and laser beam receivers. This enables the additive manufacturing system to calibrate the printer agents in two-dimensions (e.g. on a plane) and/or in three-dimensions. Further pairs of transmitters and receivers may be provided for redundancy.

In some embodiments, the laser transmitter and/or laser receiver is arranged to move in order to enable the calibration of multiple printer agents. For example, where the agents are only capable of working within a limited workspace, the transmitter and receiver may be arranged to move along the additive manufacturing system to enable calibration of agents with different workspaces.

As shown in FIGS. 24c and 24d, the pairs of receivers and transmitters are typically arranged so that the laser beams pass over an origin point of the additive manufacturing system so that the printer agents can be calibrated with reference to this origin point.

FIG. 24a shows a method of calibrating printer agents of an additive manufacturing system. The method is typically carried out by a computer device associated with the additive manufacturing system (e.g. the coordinator).

In a first step 191, a printer agent is moved perpendicular to the laser beam so as to move from a space away from the laser beam towards the laser beam.

In a second step 192, the computer device determines that the printer agent has cut the laser beam (e.g. by detecting the point at which the laser beam receiver is no longer receiving the laser beam and/or by detecting a drop in the amount of light being received by the laser beam receiver). More generally, the computer device detects a (e.g. first or earliest) position at which that the printer agent disrupts the laser beam

In a third step 193, the computer device determines a position of the printer agent based on the cutting position (e.g. determines a point at which the printer agent is located over an origin point of the additive manufacturing system). In this regard, the laser beam is typically arranged to pass over the origin point so that the computer device can determine the printer agent is at this origin point when the beam is cut.

This method may be performed for more than one direction. Typically, the method is performed for each of an x-direction and a y-direction.

Typically, the printer agent is moved slowly (e.g. at less than or equal to 0.1 m/s and/or less than or equal to 0.01 m/s, and/or less than or equal to 1 mm/s) to ensure that the printer agent does not overshoot the laser beam and to enable an accurate link to be drawn between a time at which the beam is cut and a position of the printer agent. In order to avoid such overshooting while achieving a rapid calibration, the calibration method may comprise a two stage method where in a first stage the printer agent is moved relatively quickly towards the laser beam (e.g. at least 0.1 m/s) in order to cut the laser beam and to find the approximate position of the laser beam; and in a second stage the printer agent is moved relatively slowly across a smaller path (e.g. at no more than 0.05 m/s) in order to find a more precise position of the laser beam. The smaller path of the second stage is generated based on the approximate position of the laser beam determined during the first stage (e.g. so that the second path starts near to the laser beam).

The calibration process is typically repeated for each of the printer agents. Typically, the same transmitter/receiver pair is used to calibrate a plurality of printer agents, as shown in FIG. 24e. In some embodiments, different printer agents use different transmitter/receiver pairs for calibration (e.g. where limitations in the possible movement of the printer agents prevent the use of the same transmitter/receiver pair for all agents).

It will be appreciated that the printer agent does not need to be moved solely perpendicularly to the laser beam, that is the printer agent could be moved at an angle to the laser beam. Typically, the printer agent is moved solely perpendicularly to the laser beam.

As shown in FIG. 24e, the diameter of the laser beam varies along the travelling direction of the beam due to divergence of the beam (e.g. the beam becomes wider further from the laser beam transmitter). Therefore, in some embodiments, the computer device is arranged to compensate for this increase in the width of the laser beam. This may comprise the computer device determining a width of the beam at a position of a printer agent and determining calibration information for the printer agent based on this width.

In some embodiments, the printer agent may be arranged to approach the laser beam from both sides of the laser beam in order to obtain a position for the laser beam in each direction. The positions of each cut of the laser beam can then be combined to find the center of the laser beam; in this regard, the divergence of the beam typically leads to a cone of light, so the center of the beam can be determined as being halfway between the two cutting positions. This method of cutting the laser beam from each side may be combined with the two stage method described above, where the printer agent may be moved quickly through the last to find the approximate position of the laser beam and may then be moved slowly through the laser beam from each side.

Referring to FIG. 24b, there is described a method of calibrating the printer agent based on cutting a laser beam from each of a first and second direction.

In a first, optional, step 201, the computer device moves a printer agent perpendicular to a laser beam quickly and in an optional second step 202 an approximate position of the laser beam is detected based on the laser beam being cut by the printer agent.

In a third step 203, the computer device moves the printer agent slowly towards the printer agent from a first direction and in a fourth step 204, the computer device detects when the laser beam is cut from this first direction.

In a fifth step 205, the computer device moves the printer agent slowly towards the printer agent from a second direction and in a sixth step 206, the computer device detects when the laser beam is cut from this second direction.

The computer device then determines calibration information (e.g. an origin position) for the printer agent in dependence on the first cutting position and the second cutting position. The origin position may be determined as the center of the first cutting position and the second cutting position (which is approximately the center of the laser beam). Similarly, the computer device may calculate a width of the laser beam based on the distance between the first cutting position and the second cutting position and determine the calibration position in dependence on the calculated width.

In some embodiments, the cutting positions are detected as the first point at which the printer agent contacts the laser beam. In such embodiments, the cutting may be detected as a drop in the amount of light received by the receiver (though due to the width of the beam some light will still be received).

In some embodiments, the cutting positions are detected as the point at which all of, or substantially all of, the light transmitted by the transmitter is blocked from the receiver. In such embodiments, the point at which the a printer agent approaching from a first side of the laser beam printer agent has reached the second side of the laser beam is detected.

The above methods have been described with reference to the printer agents cutting the laser beam; typically, each printer agent comprises, or is associated with, a beam blocker component that is arranged to block the laser beam to assist in the calibration of the printer agent.

In some embodiments, the printer agents each comprise, or are associated with, laser beam receivers so that the cutting of the laser beam by a printer agent can be determined by a receiver associated with the printer agent first receiving light from the transmitter. Similarly, each printer agent may comprise a transmitter so that the cutting of the beam can be detected as the (e.g. shared) receiver first receiving light from a laser beam associated with a printer agent.

While the embodiment described above has considered a laser beam transmitter and a laser beam receiver, it will be appreciated that more generally and beam receiver and transmitter could be used. For example, a radar beam receiver/transmitter could be used or a directional speaker and a microphone could be used.

### Alternatives and Modifications

It will be understood that the present invention has been described above purely by way of example, and modifications of detail can be made within the scope of the invention.

Reference numerals appearing in the claims are by way of illustration only and shall have no limiting effect on the scope of the claims.

1. A method of determining regions for an additive manufacturing system comprising a plurality of printer agents, wherein each of the printer agents is associated with a workspace, and wherein the printer agents are arranged so that at least one pair of adjacent printer agents has intersecting workspaces, the method comprising:
identifying a layer of a part;
determining a plurality of separate regions associated with the layer, wherein each region is assigned to one of the printer agents; and
outputting the plurality of regions;
wherein a dimension of each region is equal to and/or greater than a minimum possible separation between the printer agents adjacent said region.

2. The method of claim 1, comprising determining the regions such that a dimension of each region is equal to and/or greater than a minimum possible separation between each printer agent with a workspace that includes at least a part of said region.

3. The method of claim 1, wherein the minimum possible separation between printer agents is dependent on one or more of: a property of the printer agents; a dimension of the printer agents; and a user input.

4. The method of claim 1, wherein outputting the regions comprises one or more of:
transmitting the regions to the additive manufacturing system;
printing the regions; and
determining toolpaths for each of the printer agents in dependence on the regions and outputting the toolpaths.

5. The method of claim 1, comprising one or more of:
assigning each of the regions to a single printer agent;
assigning a plurality of regions to one or more of the printer agents;
assigning a plurality of regions to each of the printer agents; and
assigning the same number of regions to each of the printer agents.

6. The method of claim 1, wherein each of the regions is associated with a printing step, wherein the associated printer agent is arranged to print the material in said region during said printing step, wherein, for each printing step, each printer agent is assigned to a region, preferably to a single region.

7. The method of claim 6, comprising determining an order of the printing steps and outputting the order.

8. The method of claim 6, wherein the regions and the printing steps are determined so that, for each printing step, each of the regions printed during said printing step is separated by at least one other region.

9. The method of claim 1, comprising determining the regions in dependence on one or more of:
an area of material within each of said regions;
a contribution of the printer agents;
a movement of the printer agents;
a material usage of the printer agents; and
a printing time of the printer agents.

10. The method of claim 1, comprising determining the regions:
so as to minimise the total printing time and/or so as to minimise the printing time for one of the printing steps; and/or
so as to minimise the maximum printing time of a printer agent and/or so as to minimise the maximum printing time of a printer agent for each of the printing steps; and/or
so as to minimise a movement of the printer agents and/or so as to minimise a material usage of the printer agents.

11. (canceled)

12. The method of claim 1, wherein determining the regions comprises determining the regions such that each region is located entirely within the workspace of one of the printer agents.

13. (canceled)

14. The method of claim 1, comprising assigning a number of regions to each printer agent that is:
dependent on a dimensionality of a configuration of the printer agents and/or that is equal to and/or greater than to the number of printer agents multiplied by two to the power of the number of dimensions of the arrangement of the agents; and/or
equal to and/or greater than the number of printer agents multiplied by two; and/equal to and/or greater than the number of printer agents multiplied by four.

15. (canceled)

16. The method of claim 1, comprising determining a configuration of printer agents and/or an optimal configuration of printer agents.

17. The method of claim 1, comprising determining the regions in dependence on an overlap parameter, wherein the overlap parameter is dependent on one or more of: a user input; a type of material being used by the printer agents; and a geometry of the part and/or of a layer of the part.

18. The method of claim 1, comprising:
identifying a first region of a first layer of the part, the first region being associated with a first printer agent; and
determining a second region for a second layer of the part in dependence on the second region of the second layer overlapping the first region of the first layer, the second region being associated with a second printer agent.

19.-46. (canceled)

47. An apparatus for determining regions for an additive manufacturing system comprising a plurality of printer agents, wherein each of the printer agents is associated with a workspace, and wherein the printer agents are arranged so that at least one pair of adjacent printer agents has intersecting workspaces, the apparatus comprising:
a processor for:
identifying a layer of a part; and
determining a plurality of separate regions associated with the layer, wherein each region is assigned to one of the printer agents; and
a user interface and/or a communication interface for outputting the plurality of regions;
wherein a dimension of each region is equal to and/or greater than a minimum possible separation between the printer agents adjacent said region.

48.-50. (canceled)

51. A system comprising:
an additive manufacturing system comprising a plurality of printer agents, wherein each of the printer agents is associated with a workspace, and wherein the printer agents are arranged so that at least one pair of adjacent printer agents has intersecting workspaces; and
the apparatus of claim 47.

52.-61. (canceled)

62. The method of claim 16, comprising determining a configuration of printer agents from a set of possible configurations.

63. The method of claim 1, wherein the printer agents are reconfigurable so as to change the workspaces associated with the printer agents.

64. The method of claim 63, comprising:
identifying a plurality of layers of a part; and
for each layer of the plurality of layers:
determining a configuration of the printer agents based on the geometry of the layer, the configuration being determined such that at least one pair of adjacent printer agents has intersecting workspaces; and
determining a plurality of separate regions associated with the layer, wherein:
each region is assigned to a single one of the printer agents;
each region is associated with a single printing step, wherein the printer agent to which each region is assigned is arranged to print the material in that region during the associated printing step; and
the regions and the printing steps are determined so that, for each printing step, each of the regions assigned to be printed during said printing step are separated by at least one other region; and
outputting the plurality of regions.
